(19) United States
(12) Patent Application Publication
(10) Pub. No.: US 2026/0247305 A1
(43) Pub. Date: Aug. 20, 2026

(54) TRANSMIT POWER FOR INTRA BAND CA

(71) Applicant: LG ELECTRONICS INC., Seoul (KR)

(72) Inventors: Yoonoh YANG, Seoul (KR); Sangwook LEE, Seoul (KR); Joongkwan HUH, Seoul (KR); Jinyup HWANG, Seoul (KR); Jinwoong PARK, Seoul (KR); Yunsik NA, Seoul (KR)

(73) Assignee: LG ELECTRONICS INC., Seoul (KR)

(21) Appl. No.: 19/164,170

(22) PCT Filed: Mar. 28, 2024
(86) PCT No.: PCT/KR2024/003909

§ 371 Date: Sep. 10, 2025

Related U.S. Application Data
(60) Provisional application No. 63/455,576, filed on Mar. 30, 2023.

(51) Int. Cl. H04W 52/36

(52) U.S. Cl. CPC H04W 52/367

(57) ABSTRACT

The present disclosure provides a UE. The UE includes at least one transceiver; at least one processor; and at least one memory that stores instructions and is operatively electrically connectable with the at least one processor. Operations performed based on the command being executed by the at least one processor may include: transmitting capability information to a base station; and transmitting uplink signal based on a transmission power.

### CROSS-REFERENCE TO RELATED APPLICATION(S)

This application is the National Stage filing under 35 U.S.C. 371 of International Application No. PCT/KR2024/003909, filed on Mar. 28, 2024, which claims the benefit of U.S. Provisional Application No. 63/455,576, filed on Mar. 30, 2023, the contents of which are all incorporated by reference herein in their entirety.

### TECHNICAL FIELD

The present specification relates to a radio communication.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 110 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

Communication based on unlicensed band is introduced in NR. However, Radio Frequency (RF) requirements for a UE supporting 23 dBm output power and intra band Carrier Aggregation (CA) was not defined. Therefore, the UE cannot perform operations related to intra band CA for the unlicensed band.

### SUMMARY

In one aspect, a UE is provided. The UE includes at least one transceiver; at least one processor; and at least one memory that stores instructions and is operatively electrically connectable with the at least one processor. Operations performed based on the command being executed by the at least one processor may include: transmitting capability information to a base station; and transmitting uplink signal based on a transmission power.

In another aspect, a method performed by the UE is provided.

In one aspect, a base station is provided. The base station includes at least one transceiver; at least one processor; and at least one memory that stores instructions and is operatively electrically connectable with the at least one processor. Operations performed based on the command being executed by the at least one processor may include: receiving capability information to from a UE; and receiving uplink signal transmitted based on a transmission power from the UE.

In another aspect, a method by which the base station performs is provided.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 is a diagram showing an example of a communication structure that can be provided in a 6G system.

FIG. 5 shows an example of an electromagnetic spectrum.

FIGS. 6a through 6e shows an example of RACH procedures applicable to an embodiment of the present disclosure.

FIG. 7 illustrates an example of transmission power for uplink shared channel according to an embodiment of the present disclosure.

FIG. 8 illustrates an example of transmission power for uplink control channel according to an embodiment of the present disclosure.

FIG. 9 illustrates examples of operations according to an embodiment of the present disclosure.

FIG. 10 illustrates an example of an operation according to an embodiment of the present disclosure.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regard to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

Although a user equipment (UE) is illustrated by way of example in the accompanying drawings, the illustrated UE may be referred to as a terminal, mobile equipment (ME), and the like. In addition, the UE may be a portable device such as a notebook computer, a mobile phone, a PDA, a smartphone, and a multimedia device or may be a non-portable device such as a PC or a vehicle-mounted device.

Hereinafter, a UE is used as an example of a wireless communication device (or a wireless device or wireless equipment) capable of wireless communication. An operation performed by a UE may be performed by a wireless communication device. A wireless communication device may also be referred to as a wireless device, wireless equipment, or the like. Hereinafter, AMF may mean an AMF node, SMF may mean an SMF node, and UPF may mean a UPF node.

A base station used below generally refers to a fixed station communicating with a wireless device and may also be referred as an evolved-NodeB (eNodeB), an evolved-NodeB (eNB), a base transceiver system (BTS), an access point, and a next generation NodeB (gNB).

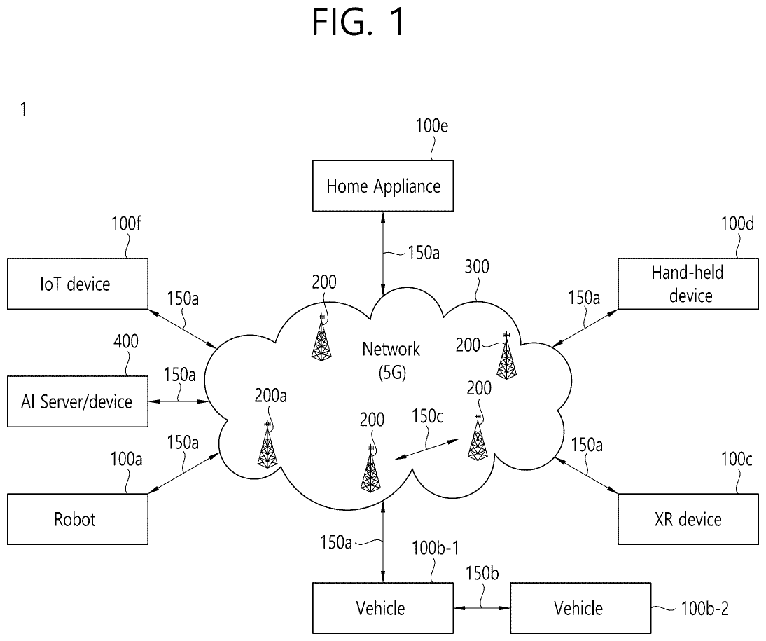

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities. NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW). FR2 may include FR 2-1 and FR 2-2, as shown in the examples in Table 1 and Table 2.

TABLE 1

| Frequency Range | | Corresponding frequency | | |
|---|---|---|---|---|
| designation | | range | Subcarrier Spacing | |
| FR1 | | 450 MHz-6000 MHz | 15, 30, 60 | kHz |
| FR2 | FR2-1 | 24250 MHz-52600 MHz | 60, 120, 240 | kHz |
| | FR2-2 | 57000 MHz-71000 MHz | 120, 480, 960 | kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | | Corresponding | Subcarrier |
|---|---|---|---|
| designation | | frequency range | Spacing |
| FR1 | | 410 MHz-7125 MHz | 15, 30, 60 kHz |
| FR2 | FR2-1 | 24250 MHz-52600 MHz | 60, 120, 240 kHz |
| | FR2-2 | 57000 MHz-71000 MHz | 120, 480, 960 kHz |

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally, and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally, and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

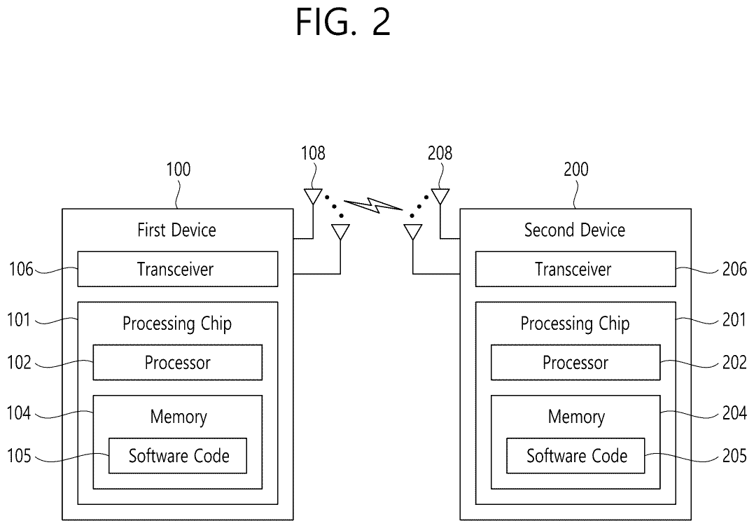

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with radio frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

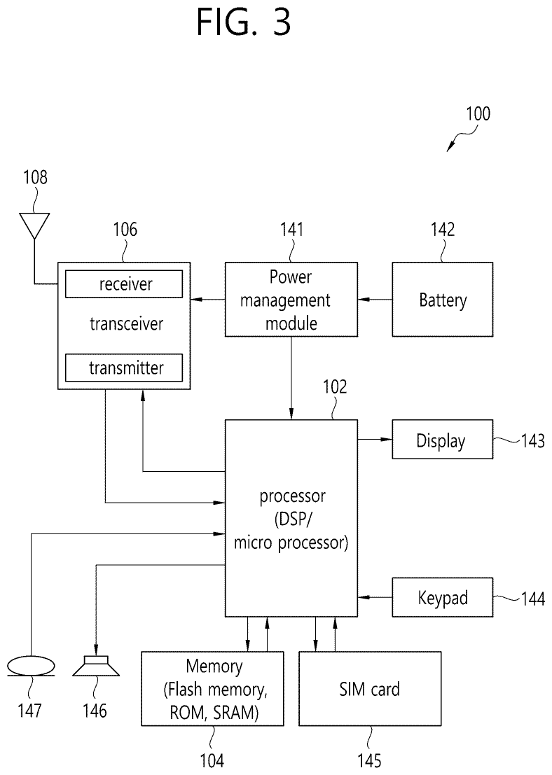

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory unit 130 may be configured by a RAM, a DRAM, a ROM, a flash memory, a volatile memory, a non-volatile memory, and/or a combination thereof.

### <Operating Bands of NR>.

The operating bands in NR are as follows

The operating bands in Table 3 below are the reframed operating bands from the operating bands of LTE/LTE-A. This is referred to as the FR1 band.

TABLE 3

| NR | Uplink (UL) | Downlink(DL) | |
|---|---|---|---|
| operating | operating band | operating band | Duplex |
| bands | F_{UL}_low-F_{UL}_high | F_{DL}_low-F_{DL}_high | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-2690 MHz | FDD |
| n8 | 880 MHz-915 MHz | 925 MHz-960 MHz | FDD |
| n12 | 699 MHz-716 MHz | 729 MHz-746 MHz | FDD |
| n20 | 832 MHz-862 MHz | 791 MHz-821 MHz | FDD |
| n25 | 1850 MHz-1915 MHz | 1930 MHz-1995 MHz | FDD |
| n28 | 703 MHz-748 MHz | 758 MHz-803 MHz | FDD |
| n34 | 2010 MHz-2025 MHz | 2010 MHz-2025 MHz | TDD |
| n38 | 2570 MHz-2620 MHz | 2570 MHz-2620 MHz | TDD |
| n39 | 1880 MHz-1920 MHz | 1880 MHz-1920 MHz | TDD |
| n40 | 2300 MHz-2400 MHz | 2300 MHz-2400 MHz | TDD |
| n41 | 2496 MHz-2690 MHz | 2496 MHz-2690 MHz | TDD |
| n50 | 1432 MHz-1517 MHz | 1432 MHz-1517 MHz | TDD1 |
| n51 | 1427 MHz-1432 MHz | 1427 MHz-1432 MHz | TDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n74 | 1427 MHz-1470 MHz | 1475 MHz-1518 MHz | FDD |
| n75 | N/A | 1432 MHz-1517 MHz | SDL |
| n76 | N/A | 1427 MHz-1432 MHz | SDL |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |
| n86 | 1710 MHz-1780 MHz | N/A | SUL |

The table below shows the NR operating band defined at high frequencies. This is called the FR2 band.

TABLE 4

| NR | Uplink (UL) | Downlink(DL) | |
|---|---|---|---|
| Operating | operating band | operating band | Duplex |
| band | F_{UL}_low-F_{UL}_high | F_{DL}_low-F_{DL}_high | Mode |
| n257 | 26500 MHz-29500 MHz | 26500 MHz-29500 MHz | TDD |
| n258 | 24250 MHz-27500 MHz | 24250 MHz-27500 MHz | TDD |
| n259 | 37000 MHz-40000 MHz | 37000 MHz-40000 MHz | TDD |
| n260 | 37000 MHz-40000 MHz | 37000 MHz-40000 MHz | FDD |
| n261 | 27500 MHz-28350 MHz | 27500 MHz-28350 MHz | FDD |

### <6G System General>

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 4 shows the requirements of the 6G system.

TABLE 5

| | |
|---|---|
| Per device peak data rate | 1 Tbps |
| E2E latency | 1 ms |
| Maximum spectral efficiency | 100 bps/Hz |
| Mobility support | Up to 1000 km/hr |
| Satellite integration | Fully |
| AI | Fully |
| Autonomous vehicle | Fully |
| XR | Fully |
| Haptic Communication | Fully |

The 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

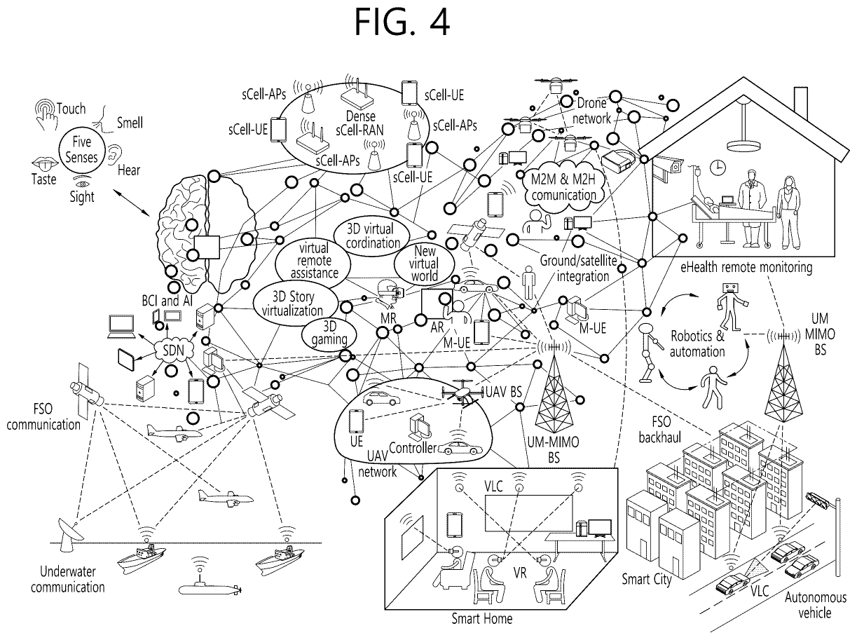

FIG. 4 is a diagram showing an example of a communication structure that can be provided in a 6G system.

The 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimension connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduces costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

### <Core Implementation Technology of 6G System>

### Artificial Intelligence

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. In addition, machine learning may be used for antenna selection, power control, symbol detection, etc. in the MIMO system.

Machine learning refers to a series of operations to train a machine in order to create a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method, a recurrent Boltzmman machine (RNN) method and a spiking neural network (SNN). Such a learning model is applicable.

### THz (Terahertz) Communication

A data rate may increase by increasing bandwidth. This may be performed by using sub-TH communication with wide bandwidth and applying advanced massive MIMO technology. THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

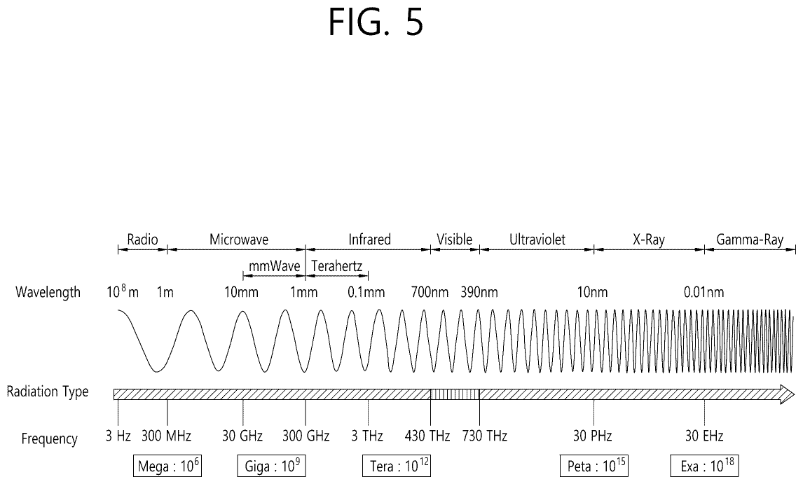

FIG. 5 shows an example of an electromagnetic spectrum.

The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### Large-Scale MIMO

One of core technologies for improving spectrum efficiency is MIMO technology. When MIMO technology is improved, spectrum efficiency is also improved. Accordingly, massive MIMO technology will be important in the 6G system. Since MIMO technology uses multiple paths, multiplexing technology and beam generation and management technology suitable for the THz band should be significantly considered such that data signals are transmitted through one or more paths.

### Hologram Beamforming

Beamforming is a signal processing procedure that adjusts an antenna array to transmit radio signals in a specific direction. This is a subset of smart antennas or advanced antenna systems. Beamforming technology has several advantages, such as high signal-to-noise ratio, interference prevention and rejection, and high network efficiency. Hologram Beamforming (HBF) is a new beamforming method that differs significantly from MIMO systems because this uses a software-defined antenna. HBF will be a very effective approach for efficient and flexible transmission and reception of signals in multi-antenna communication devices in 6G.

### Optical Wireless Technology

Optical wireless communication (OWC) is a form of optical communication that uses visible light, infrared light (IR), or ultraviolet light (UV) to carry signals. OWC operating in the visible light band (e.g., 390 to 750 nm) is commonly referred to as visible light communication (VLC). VLC implementations can utilize light-emitting diodes (LEDs). VLC can be used in a variety of applications, including wireless local area networks, wireless personal area networks, and vehicular networks.

VLC has several advantages over RF-based technologies. First, the spectrum occupied by VLC is free/unlicensed and can provide extensive bandwidth (THz-level bandwidth). Second, VLC rarely causes significant interference to other electromagnetic devices; therefore, VLC can be applied in sensitive electromagnetic interference applications such as aircraft and hospitals. Third, VLC has strengths in communication security and privacy. The transmission medium of VLC-based networks, namely visible light, cannot pass through walls and other opaque obstacles. Therefore, the transmission range of VLC can be limited to indoors, which can protect users' privacy and sensitive information. Fourth, VLC can use any light source as a base station, eliminating the need for expensive base stations.

Free-space optical communication (FSO) is an optical communication technology that uses light propagating in free space, such as air, outer space, and vacuum, to wirelessly transmit data for telecommunications or computer networking. FSO can be used as a point-to-point OWC system on the ground. FSO can operate in the near-infrared frequency (750-1600 nm). Laser transmitters may be used in FSO implementations, and FSO can provide high data rates (e.g., 10 Gbit/s), providing a potential solution to backhaul bottlenecks.

These OWC technologies are planned for 6G communications in addition to RF-based communications for all possible device-to-access networks. These networks will access network-to-backhaul/fronthaul network connections. OWC technology has already been in use since 4G communication systems, but will be more widely used to meet the needs of 6G communication systems. OWC technologies such as light fidelity, visible light communication, optical camera communication, and FSO communication based on optical bands are already well-known technologies. Communication based on optical wireless technology can provide extremely high data rates, low latency, and secure communication.

Light Detection And Ranging (LiDAR) is also based on the optical band and can be utilized in 6G communications for ultra-high resolution 3D mapping. LiDAR is a remote sensing method that uses near-infrared, visible, and ultraviolet light to illuminate an object, and the reflected light is detected by a light sensor to measure distance. LiDAR can be used for fully automated driving of cars.

### FSO Backhaul Network

The characteristics of the transmitter and receiver of the FSO system are similar to those of an optical fiber network. Accordingly, data transmission of the FSO system similar to that of the optical fiber system. Accordingly, FSO may be a good technology for providing backhaul connection in the 6G system along with the optical fiber network. When FSO is used, very long-distance communication is possible even at a distance of 10,000 km or more. FSO supports mass backhaul connections for remote and non-remote areas such as sea, space, underwater and isolated islands. FSO also supports cellular base station connections.

### Non-Terrestrial Networks (NTN)

The 6G system will integrate terrestrial and aerial networks to support vertically expanding user communications. 3D BS will be delivered via low-orbit satellites and UAVs. Adding a new dimension in terms of altitude and associated degrees of freedom makes 3D connectivity quite different from traditional 2D networks. NR considers Non-Terrestrial Networks (NTNs) as one way to accomplish this. An NTN is a network or network segment that uses RF resources aboard a satellite (or UAS platform). There are two common scenarios for NTNs that provide access to user equipment: transparent payloads and regenerative payloads. The following are the basic elements of an NTN.
One or more sat-gateways that connect the NTN to the public data network.
GEO satellites are fed by one or several satellite gateways deployed across the satellite target range (e.g., regional or continental coverage). We assume that the UEs in a cell are served by only one sat-gateway.
Non-GEO satellites that are continuously serviced by one or multiple satellite gateways at a time. The system ensures service and feeder link continuity between successively serviced satellite gateways with a time duration sufficient to allow for mobility anchoring and handover.
The feeder link or radio link between the satellite gateway and the satellite (or UAS platform).
The service link or radio link between the user equipment and the satellite (or UAS platform).
A satellite (or UAS platform) that can implement transparent or regenerative (with onboard processing) payloads. Satellite (or UAS platform) generated beams typically produce multiple beams for a given service area, depending on the field of view. The footprint of the beam is typically elliptical. The field of view of the satellite (or UAS platform) depends on the onboard antenna diagram and the minimum angle of attack.
Transparent payload: Radio frequency filtering, frequency conversion, and amplification, so the waveform signal repeated by the payload is unchanged.
Regenerative payload: radio frequency filtering, frequency conversion and amplification, demodulation/decryption, switching and/or routing, and coding/modulation. This is effectively the same as having all or part of the base station functions (e.g., gNB) on board a satellite (or UAS platform).
For satellite deployments, optionally an inter-satellite link (ISL). This requires a regenerative payload on the satellite. ISLs can operate at RF frequencies or in the optical band.
User equipment is served by satellites (or UAS platforms) within the targeted coverage area.

Typically, GEO satellites and UAS are used to provide continental, regional, or local services.

Typically, constellations in LEO and MEO are used to provide coverage in both the Northern and Southern Hemispheres. In some cases, constellations can also provide global coverage, including polar regions. The latter requires proper orbital inclination, sufficient beams generated, and links between satellites.

### Quantum Communication

Quantum communication is a next-generation communication technology that can overcome the limitations of conventional communication such as security and high-speed computation by applying quantum mechanical properties to the field of information and communication. Quantum communication provides a means of generating, transmitting, processing, and storing information that cannot be expressed in the form of 0s and 1s according to the binary bit information used in existing communication technologies. In conventional communication technologies, wavelengths or amplitudes are used to transmit information between the transmitting and receiving ends, but in quantum communication, photons, the smallest unit of light, are used to transmit information between the transmitting and receiving ends. In particular, in the case of quantum communication, quantum uncertainty and quantum irreversibility can be used for the polarization or phase difference of photons (light), so quantum communication has the characteristic of being able to communicate with perfect security. In addition, quantum communication can also enable ultra-high-speed communication using quantum entanglement under certain conditions.

### Cell-free Communication

Tight integration of multiple frequencies and heterogeneous communication technologies is critical in 6G systems. As a result, users can seamlessly move from one network to another without having to create any manual configurations on their devices. The best network is automatically selected from the available communication technologies. This will break the limitations of the cell concept in wireless communication. Currently, user movement from one cell to other causes too many handovers in dense networks, resulting in handover failures, handover delays, data loss, and ping-pong effects. 6G cell-free communication will overcome all this and provide better QoS.

Cell-free communication is defined as “a system in which a large number of geographically distributed antennas (APs) cooperatively serve a small number of terminals using the same time/frequency resources with the help of a fronthaul network and a CPU”. A single terminal is served by a set of multiple APs, which is called an AP cluster. There are several ways to form AP clusters, among which the method of configuring AP clusters with APs that can significantly contribute to improving the reception performance of the terminal is called the terminal-centered clustering method, and when using this method, the configuration is dynamically updated as the terminal moves. By adopting this device-centric AP clustering technique, the device is always at the center of the AP cluster and is therefore free from inter-cluster interference that can occur when the device is located at the boundary of the AP cluster. This cell-free communication will be achieved through multi-connectivity and multi-tier hybrid technologies and different heterogeneous radios in the device.

### Integration of Wireless Information and Energy Transfer (WIET)

WIET uses the same field and wave as a wireless communication system. In particular, a sensor and a smartphone will be charged using wireless power transfer during communication. WIET is a promising technology for extending the life of battery charging wireless systems. Therefore, devices without batteries will be supported in 6G communication.

### Integration of Wireless Communication and Sensing

An autonomous wireless network is a function for continuously detecting a dynamically changing environment state and exchanging information between different nodes. In 6G, sensing will be tightly integrated with communication to support autonomous systems.

### Integrated Access and Backhaul Network

In 6G, the density of access networks will be enormous. Each access network is connected by optical fiber and backhaul connection such as FSO network. To cope with a very large number of access networks, there will be a tight integration between the access and backhaul networks.

### Big Data Analysis

Big data analysis is a complex process for analyzing various large data sets or big data. This process finds information such as hidden data, unknown correlations, and customer disposition to ensure complete data management. Big data is collected from various sources such as video, social networks, images and sensors. This technology is widely used for processing massive data in the 6G system.

### Reconfigurable Intelligent Surface

There is a large body of research that considers the radio environment as a variable to be optimized along with the transmitter and receiver. The radio environment created by this approach is referred to as a Smart Radio Environment (SRE) or Intelligent Radio Environment (IRE) to highlight its fundamental differences from past design and optimization criteria. Various terms have been proposed for the reconfigurable intelligent antenna (or intelligent reconfigurable antenna technology) technology that enables SRE, including Reconfigurable Metasurfaces, Smart Large Intelligent Surfaces (SLIS), Large Intelligent Surfaces (LIS), Reconfigurable Intelligent Surface (RIS), and Intelligent Reflecting Surface (IRS).

In the case of THz band signals, there are many shadowed areas caused by obstacles due to the strong straightness of the signal, and RIS technology is important to expand the communication area by installing RIS near these shadowed areas, strengthening communication stability and enabling additional value-added services. RIS is an artificial surface made of electromagnetic materials that can alter the propagation of incoming and outgoing radio waves. While RIS can be seen as an extension of massive MIMO, it has a different array structure and operating mechanism than massive MIMO. RIS also has the advantage of lower power consumption because it operates as a reconfigurable reflector with passive elements, meaning it only passively reflects the signal without using an active RF chain. In addition, each of the passive reflectors in the RIS must independently adjust the phase shift of the incident signal, which can be advantageous for wireless communication channels. By properly adjusting the phase shift through the RIS controller, the reflected signal can be gathered at the target receiver to boost the received signal power.

In addition to reflecting radio signals, there are also RISs that can adjust transmission and refraction properties, and these RISs are mainly used for O2I (Outdoor to Indoor). Recently, STAR-RIS (Simultaneous Transmission and Reflection RIS), which provides transmission while reflecting, has also been actively researched.

### Metaverse

Metaverse is a portmanteau of the words “meta” meaning virtual, transcendent, and “universe” meaning space. Generally speaking, the metaverse is a three-dimensional virtual space where the same social and economic activities as in the real world are commonplace.

Extended Reality (XR), a key technology enabling the Metaverse, is the fusion of the virtual and the real, which can extend the experience of reality and provide a unique sense of immersion. The high bandwidth and low latency of 6G networks will enable users to experience more immersive virtual reality (VR) and augmented reality (AR) experiences.

### Autonomous Driving, Self-Driving

For perfect autonomous driving, vehicles must communicate with each other to inform each other of dangerous situations, or with infrastructure such as parking lots and traffic lights to check information such as the location of parking information and signal change times. Vehicle-to-Everything (V2X), a key element in building an autonomous driving infrastructure, is a technology that enables vehicles to communicate and share information with various elements on the road, such as vehicle-to-vehicle (V2V) and vehicle-to-infrastructure (V2I), for autonomous driving.

In order to maximize the performance of autonomous driving and ensure high safety, fast transmission speeds and low latency technologies are essential. In addition, in the future, autonomous driving will go beyond delivering warnings and guidance messages to the driver to actively intervene in vehicle operation and directly control the vehicle in dangerous situations, and the amount of information that needs to be transmitted and received will be enormous, so 6G is expected to maximize autonomous driving with faster transmission speeds and lower latency than 5G.

### Unmanned Aerial Vehicle (UAV)

An unmanned aerial vehicle (UAV) or drone will be an important factor in 6G wireless communication. In most cases, a high-speed data wireless connection is provided using UAV technology. A base station entity is installed in the UAV to provide cellular connectivity. UAVs have certain features, which are not found in fixed base station infrastructures, such as easy deployment, strong line-of-sight links, and mobility-controlled degrees of freedom. During emergencies such as natural disasters, the deployment of terrestrial telecommunications infrastructure is not economically feasible and sometimes services cannot be provided in volatile environments. The UAV can easily handle this situation. The UAV will be a new paradigm in the field of wireless communications. This technology facilitates the three basic requirements of wireless networks, such as eMBB, URLLC and mMTC. The UAV can also serve a number of purposes, such as network connectivity improvement, fire detection, disaster emergency services, security and surveillance, pollution monitoring, parking monitoring, and accident monitoring. Therefore, UAV technology is recognized as one of the most important technologies for 6G communication.

### Block-Chain

A blockchain will be important technology for managing large amounts of data in future communication systems. The blockchain is a form of distributed ledger technology, and distributed ledger is a database distributed across numerous nodes or computing devices. Each node duplicates and stores the same copy of the ledger. The blockchain is managed through a peer-to-peer (P2P) network. This may exist without being managed by a centralized institution or server. Blockchain data is collected together and organized into blocks. The blocks are connected to each other and protected using encryption. The blockchain completely complements large-scale IoT through improved interoperability, security, privacy, stability and scalability. Accordingly, the blockchain technology provides several functions such as interoperability between devices, high-capacity data traceability, autonomous interaction of different IoT systems, and large-scale connection stability of 6G communication systems.

### <Random Access Channel (RACH) Procedure>

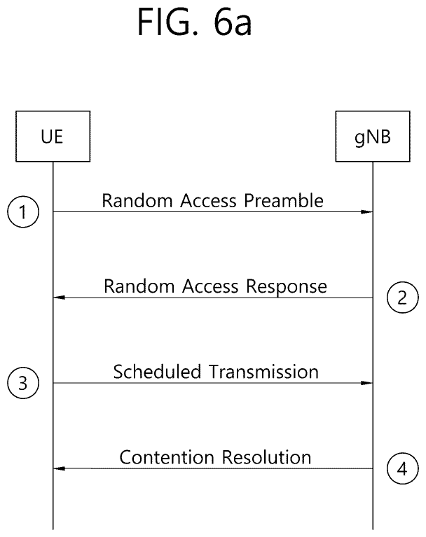

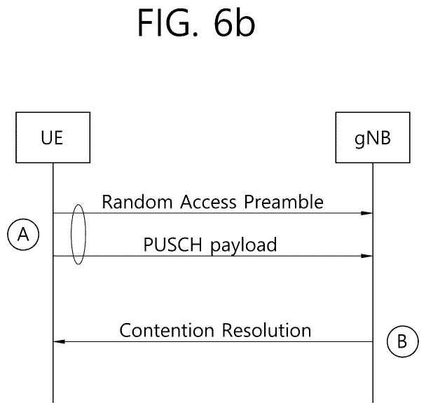

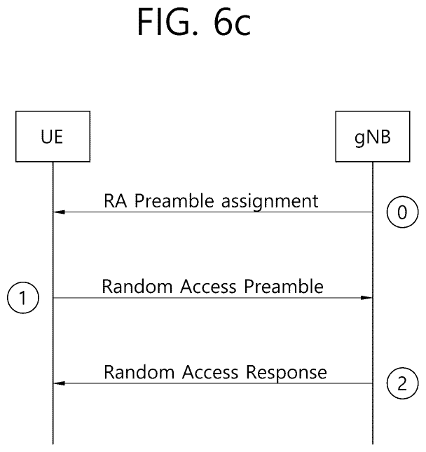

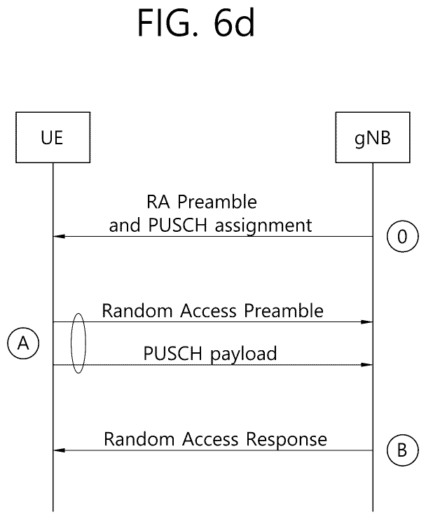

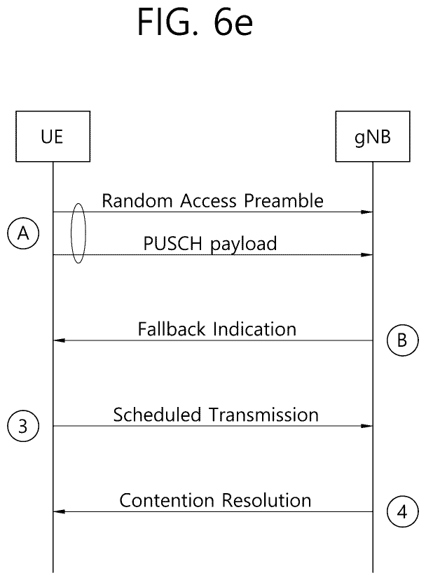

FIGS. 6a through 6e shows an example of RACH procedures applicable to an embodiment of the present disclosure.

Referring to FIGS. 6a through 6e, a RACH procedure is described, according to one embodiment of the present disclosure. The embodiments of FIGS. 6a through 6e may be combined with various embodiments of the present disclosure.

In one embodiment of the disclosure, where RF requirements (e.g., Tx RF performance requirements and/or Rx RF performance requirements) are described, the UE may satisfy those RF requirements. For example, a UE may be tested to satisfy RF requirements (e.g., Tx RF performance requirements and/or Rx Rf performance requirements) according to one embodiment of the disclosure. In one embodiment of the disclosure, a UE that meets these RF requirements may perform the RACH procedure. When the UE transmits messages, data, signaling, etc. to the gNB, the UE satisfies the Tx RF performance requirements described in the first embodiment of this specification. When the UE receives messages, data, signaling, etc. from the gNB, the UE satisfies the Rx RF performance requirements described in the first embodiment of this specification.

To connect the UE to the 5G network, the UE and the 5G network must synchronize in the uplink and downlink. Downlink synchronization is performed when the UE successfully decodes the SSB transmitted by the gNB. To establish the uplink synchronization and RRC connection, the UE shall perform the RACH random access procedure.

Two types of random access procedures are supported. The two types of random access procedures include a four-stage Random Access (RA) type using MSG1 and a two-stage RA type using MSGA.

The two types of RA procedures can support Contention Based Random Access (CBRA) and Contention Free Random Access (CFRA), as shown in FIG. 6a through FIG. 6e below, respectively. The UE may select the random access type at the beginning of the random access procedure, depending on the network configuration.

Referring to FIG. 6a and FIG. 6c, a four-stage RA type using MSG1 is illustrated.

Step 4 The MSG1 of RA type contains the preamble of the PRACH. The UE transmits the MSG1. After the UE sends the MSG1, the UE monitors the network for a response within the set window.

For CBRA according to the example of FIG. 6a, when the UE receives a random access response (MSG2) from the gNB, the UE may transmit MSG3 using the UL grant scheduled by the response message. The UE may then monitor the contention resolution. If contention resolution is not successful after the MSG3 (re) transmission, the UE shall perform the MSG1 transmission again.

For CFRA according to the example in FIG. 6c, a dedicated preamble for MSG1 transmission is allocated by the network. The gNB sends the RA preamble assignment to the UE. The UE transmits an MSG1 containing the random access preamble to the gNB. Upon receiving the random access response from the network, the UE terminates the random access procedure.

Referring to FIGS. 6b, 6d, and 6e, a two-stage RA type is described. The MSGA of the two-stage RA type includes a random access preamble on the PRACH and a PUSCH payload. After the UE transmits the MSGA, the UE monitors the response from the network within a set window.

For CBRA according to the example of FIG. 6b, after the UE receives the network response (e.g., MSGB), if the contention resolution is successful, the UE terminates the random access procedure. If the fallback indication is received within the MSGB, the UE performs the MSG3 transmission using the UL grant scheduled in the fallback indication and monitors the contention resolution, as shown in FIG. 6e. If contention resolution is not successful after the MSG3 (re) transmission, the UE shall perform the MSGA transmission again.

In the case of CFRA according to the example of FIG. 6d, the UE may receive RA preamble allocation and PUSCH allocation from the gNB. Dedicated preamble and PUSCH resources may then be set up for MSGA transmission. The UE transmits the MSGA. When the UE receives a network response, the UE terminates the random access procedure.

If the random access procedure of the two-stage RA type is not completed after several MSGA transmissions, the UE may be set to switch to the CBRA of the four-stage RA type.

### <The Present Disclosure of the Present Specification>

The UE may transmit uplink signal based on transmission power. The UE may determine uplink power for transmitting the uplink signal.

For example, uplink power control may be used for the uplink signal. For reference, 3GPP TS 38.101-1 17.4.0 S7.1.1 may be referred for detailed procedures to determine uplink power.

Uplink power control may be used by the UE to determine a power for uplink shared channel (e.g., (Physical uplink shared channel (PUSCH)), uplink control channel (e.g., (Physical uplink control channel (PUCCH)), sounding reference signal (SRS), and channel related to a random access (e.g., Physical random access channel (PRACH)) transmissions.

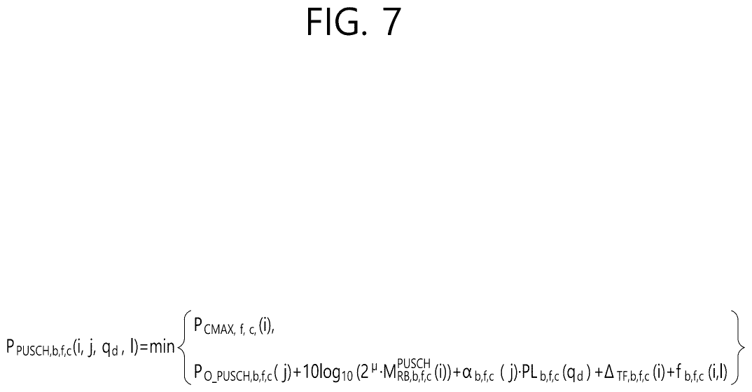

For example, for the uplink shared channel, the UE transmits a signal based on the uplink shared channel based on the configured power as the following: If a UE transmits a PUSCH on active UL BWP b of carrier f of serving cell c using parameter set configuration with index j and PUSCH power control adjustment state with index 1, the UE determines the PUSCH transmission power as P_{PUSCH,b,f,c} (i,j,q_{d},l) in PUSCH transmission occasion i. The transmission power for PUSCH, P_{PUSCH,b,f,c} (i,j,q_{d},l), may be shown in FIG. 7.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

FIG. 7 illustrates an example of thramsission power for uplink shared channel according to an embodiment of the present disclosure.

In FIG. 7, P_{CMAX,f,c}(i) may be the UE configured maximum output power for carrier f of serving cell c in PUSCH transmission occasion i. Parameters other than P_{CMAX,f,c}(i) may be defined based on based on 3GPP TS 38.213 17.4.0 S7.1.1. P_{PUSCH,b,fc}(i,j,q_{d},l) shown in FIG. 7 is an example. Transmission power for uplink shared channel is not limited to the exact same equation shown in FIG. 7. The UE may determine transmission power for uplink shared channel based on the configured maximum output power and one ore more other parameters.

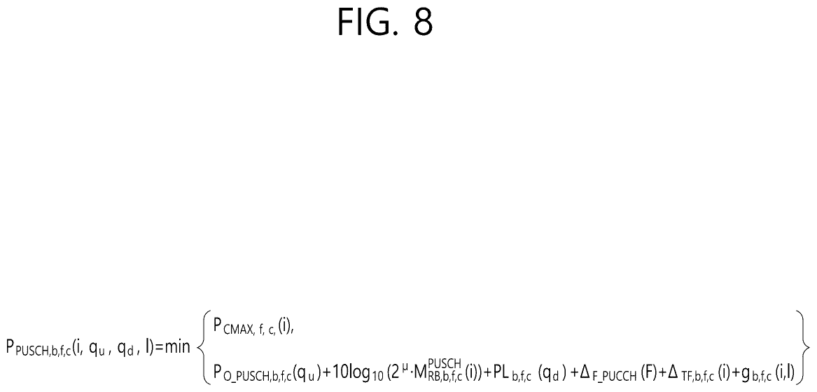

For example, for the uplink control channel, the UE transmits a signal based on the uplink control channel based on the configured power as the following: If a UE transmits a PUCCH on active UL BWP b of carrier f in the primary cell c using PUCCH power control adjustment state with index 1, the UE determines the PUCCH transmission power as P_{PUCCH,b,f,c}(i,qᵤ,q_{d},l) in PUSCH transmission occasion i. The transmission power for PUCCH, P_{PUCCH,b,f,c}(i,qᵤ,q_{d},l), may be shown in FIG. 8.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

FIG. 8 illustrates an example of transmission power for uplink control channel according to an embodiment of the present disclosure.

In FIG. 8, P_{CMAX,f,c}(i) may be the UE configured maximum output power for carrier f of serving cell c in PUSCH transmission occasion i. Parameters other than P_{CMAX,f,c}(i) may be defined based on 3GPP TS 38.213 17.4.0 S7.2.1. P_{PUSCH,b,f,c}(i,j,q_{d},l) shown in FIG. 8 is an example. Transmission power for uplink control channel is not limited to the exact same equation shown in FIG. 8. The UE may determine transmission power for uplink shared channel based on the configured maximum output power and one or more other parameters.

For example, for a a physical random access channel (PRACH), the UE may determine a transmission power for the PRACH), on active UL BWP b of carrier f of cell c based on DL RS for cell c in transmission occasion i, as the following equation.

$${P}_{PRACH , b , f , c} ( i ) = min \{ {P}_{CMAX , f , c} ( i ) , {P}_{PRACH , target , f , c} + {PL}_{b , f , c} \} [ dBm ] .$$

P_{CMAX,f,c}(i) may be the UE configured maximum output power for carrier f of serving cell c in PUSCH transmission occasion i. Parameters other than P_{CMAX,f,c}(i) may be defined based on 3GPP TS 38.213 17.4.0 S7.4.

For the maximum output power (MOP) for NR-U terminal (e.g., UE) supporting single carrier in the shared spectrum band (or shared spectrum channel access), 23 dBm is introduced, in addition to the previously defined 20 dBm of MOP. In the present disclosure, shared spectrum band may mean operating band used for the shared spectrum channel access.

However, in the shared spectrum bands, the MOP for NR-U CA terminals supporting intra-band contiguous CA was only defined as 20 dBm. Therefore, RF requirements are only defined for the UE supporting 20 dBm of MOP. Thus, there are problems that UE supporting 23 dBm of MOP cannot perform communication based NR-U CA.

UE RF performance specification (or requirements) for a UE supporting NR-U CA and 23 dBm of MOP shall be defined. For example, configured tx power for the UE supporting 23 dBm of MOP and NR-U CA needs to be defined.

According to the present disclosure, RF performance requirements (or specification) may be defined for NR-U CA UE supporting intra-band contiguous CA in shared spectrum bands.

Various examples of the present disclosure describes examples of configuring transmitted power for a UE supporting communication based on unlicensed bands and intra-band Carrier Aggregation (CA). For example, examples of the present disclosure relate to examples for configuring the transmitted power for UE supporting a NR-U (NR unlicensed band) intra band contiguous CA.

The UE needs to indicate the corresponding capability to network (NW) (e.g., a base station) and power class of the UE together. For example, the UE may transmit capability information to the NW. For example, the capability information may include the power class of the UE and information that the UE supports shared spectrum channel access and the intra-band CA. For example, the capability information may include power class capability (e.g., power class per band, or power class per band combination). If the UE support UL MIMO, the capability information may include uplink full power mode capability (e.g., Mode-full, Mode-1, Mode-2 . . . ) If the UE support Tx diversity, the capability information may include the tx diversity capability.

The NW may transmit information of the allowed UE power to the UE (for example, p-Max). Then, the UE may configure transmission power based on the information (e.g., p-Max). The UE may transmit signal based on the transmission power. And, the UE may report the configured transmission power and the power headroom (PH) to the NW. The power headroom may refer to the amount of remaining power available for transmission that the UE has before reaching its maximum transmit power limit.

In the prior arts, the UE capability signals related to power class are defined in TS38.306 V17.3.0 as follows:
Power capability per band:
ue-PowerClass,
ue-PowerClass-V1610,
ue-PowerClass-v1700
Power capability per band combination:
powerClass-v1530,
powerClass-v1610,
powerClassNRPart-r16,
intraBandPowerClass-r16,
Power capability per Feature Set (FS):
ue-PowerClassPerBandPerBC-r17.

Here, the feature set can be configured based on band combination.

The NW (e.g., a bases station) transmits information related to p-Max to the UE. For example, related signalings of p-Max from NW to UE may be:
p-Max (it corresponds to P_{EMAX,C} in Case 1 and Case 2). p-Max may mean maximum transmit power allowed in a serving cell; and/or
p-NR-FR1 or p-UE-FR1 (it corresponds to P_{EMAX,CA} in Case 1 and Case 2).

For NR-U operation, so far, UE RF requirements were defined only for single carrier. UE power class 6 was defined in Rel-17 and UE power class 3 is on-going to be defined in Rel-18. Herein, the NR-U may be interpreted as NR operation based on an unlicensed band (e.g., communication based on at least one unlicensed bands). The NR-U may also refer to shared spectrum channel access.

To compete with WiFi, NR-U CA will be defined. First, NR-U intra band contiguous CA needs to be introduced. Therefore, the UE RF requirements should related to NR-U intra band contiguous CA may be defined.

For NR-U intra band contiguous CA, NR operating bands n46, n96, and n102 may be used. Here, NR operating band, n46, n96 and n102 correspond to un-licensed band as seen in Table 5.2-1 in TS38.101-1.

TABLE 6

| | Uplink (UL) | Downlink (DL) | |
|---|---|---|---|
| | operating band | operating band | |
| NR | BS receive/UE | BS transmit/UE | |
| operating | transmit | receive | Duplex |
| band | F_{UL}_low-F_{UL}_high | F_{DL}_low-F_{DL}_high | Mode |
| n46 | 5150 MHz-5925 MHz | 5150 MHz-5925 MHz | TDD |
| | | | (NOTE 1 |
| | | | applied) |
| n96 | 5925 MHz-7125 MHz | 5925 MHz-7125 MHz | TDD |
| (NOTE 2 | | | (NOTE 1 |
| applied) | | | applied) |
| n102(NOTE 2 | 5925 MHz-6425 MHz | 5925 MHz-6425 MHz | TDD |
| applied) | | | (NOTE 1 |
| | | | applied) |

NOTE 1:
This band is restricted to operation with shared spectrum channel access as defined in TS 37.213 V17.4.0. This band is also applicable for V2X SL service.
NOTE 2:
This band is applicable only in countries/regions designating this band for shared-spectrum access use subject to country-specific conditions. This band is also applicable for V2X SL service.

Table 6 shows examples of operating bands used for shared spectrum channel access.

For the NR-U CA, CA_n96B and CA_n96C are exemplified. Here, ‘B’ and ‘C’ are NR CA bandwidth classes in Table 7 (corresponds to Table 5.3A.5-1 in TS38.101-1 V18.0.0) and correspond to 2 contiguous CCs (component carriers).

TABLE 7

| NR CA | Aggregated | Number of | Fall- |
|---|---|---|---|
| bandwidth | channel | contiguous | back |
| class | bandwidth | CC | group |
| A | BW_{Channel ≤} BW_{Channel,max} | 1 | 1, 2, 3 |
| | | | (NOTE 4 |
| | | | applied) |
| B | 20 MHz ≤ BW_{Channel}_CA ≤ | 2 | 2, 3 |
| | 100 MHz | | ^{(NOTE 4} |
| C | 100 MHz < BW_{Channel}_CA ≤ | 2 | applied) |
| | 2 × BW_{Channel,max} | | |
| D | 200 MHz < BW_{Channel}_CA ≤ | 3 | |
| | 3 × BW_{Channel,max} | | |
| E | 300 MHz < BW_{Channel}_CA ≤ | 4 | |
| | 4 × BW_{Channel,max} | | |
| G | 100 MHz < BW_{Channel}_CA ≤ | 3 | 2 |
| | 150 MHz | | |
| H | 150 MHz < BW_{Channel}_CA ≤ | 4 | |
| | 200 MHz | | |
| I | 200 MHz < BW_{Channel}_CA ≤ | 5 | |
| | 250 MHz | | |
| J | 250 MHz < BW_{Channel}_CA ≤ | 6 | |
| | 300 MHz | | |
| K | 300 MHz < BW_{Channel}_CA ≤ | 7 | |
| | 350 MHz | | |
| L | 350 MHz < BW_{Channel}_CA ≤ | 8 | |
| | 400 MHz | | |
| M^{(NOTE 3 applied)} | 50 MHz ≤ BW_{Channel}_CA ≤ | 3 | 3 |
| | 200 MHz | | ^{(NOTE 4} |
| N^{(NOTE 3 applied)} | 80 MHz ≤ BW_{Channel}_CA ≤ | 4 | applied) |
| | 300 MHz | | |
| O^{(NOTE 3 applied)} | 100 MHz < BW_{Channel}_CA ≤ | 5 | |
| | 400 MHz | | |

^{NOTE 1}:
BW_{Channel,max} is maximum channel bandwidth supported among all bands
^{NOTE 2}:
It is mandatory for a UE to be able to fallback to lower order NR CA bandwidth class configuration within a fallback group. It is not mandatory for a UE to be able to fallback to lower order NR CA bandwidth class configuration that belong to a different fallback group.
^{NOTE 3}:
This bandwidth class is only applicable to bands identified for use with shared spectrum channel access in Table 5.2-1 of TS 38.101-1.
^{NOTE 4}:
Fallback group 3 is only applicable to bands identified for use with shared spectrum channel access in Table 5.2-1 of TS 38.101-1.

Table 7 shows NR CA bandwidth classes. For example, CA_n96B may mean that NR CA bandwidth class B is used for 2 contiguous CCs configured for intra-band contiguous CA based on shared spectrum channel access.

And, both power class 5 and power class 3 may be used for the NR-U CA.

$$- power class 5 ( PC 5 ) = 20 dBm$$

$$- power class 3 ( PC 3 ) = 23 dBm$$

For example, the UE supporting power class 5 means that the UE supports maximum output power of 20 dBm. The UE supporting power class 3 means that the UE supports maximum output power of 23 dBm.

RF requirements based on the present disclosure may be defined based on the following sections related to RF requirements for intra-band contiguous CA in licensed bands. Theses sections correspond to clauses with the same name in 3GPP TS 38.101-1 V18.0.0.

### 6.2A.4.1.1 Configured Transmitted Power for Intra-Band Contiguous CA

This corresponds to S6.2A.4.1.1 of 3GPP TS 38.101-1.

For uplink carrier aggregation the UE is allowed to set its configured maximum output power P_{CMAX,c} for serving cell c and its total configured maximum output power P_{CMAX}.

The configured maximum output power P_{CMAX,c} on serving cell c shall be set as specified in clause 6.2.4 of 38. 101-1, but with MPR_{c}=MPR and A-MPR_{c}=A-MPR with MPR and A-MPR as determined by subclause 6.2A.2 of 38. 101-1 and 6.2A.3 of 38. 101-1, respectively.

For PH reporting the following exception applies: if the UE is configured with multiple uplink serving cells, the power P_{CMAX,c} used for the purpose of PH reporting on first serving cell c=c₁ does not consider for computation of the PH report transmissions on a second serving cell c₂ as exempted in subclause 7.7.1 in TS38.213 V17.4.0. There is one power management term for the UE, denoted P-MPR, and P-MPR_{c}=P-MPR.

The total configured maximum output power P_{CMAX} shall be set within the following bounds:

$${P}_{CMAX \_ L} \leq {P}_{CMAX} \leq {P}_{CMAX \_ H}$$

P_{CMAX_L} may mean a lower edge for P_{CMAX}. P_{CMAX_H} may mean a upper edge for P_{CMAX}.

For uplink intra-band contiguous carrier aggregation when same slot pattern is used in all aggregated serving cells,

$${P}_{CMAX \_ L} = MIN \{ 10 {log}_{10} \sum {p}_{EMAX , c} - Δ {T}_{C} , {P}_{EMAX , CA} , ( {P}_{PowerClass , CA} - {P}_{PowerClass , CA} ) - MAX ( MAX ( MPR , A - MPR ) + Δ {T}_{IB , c} + Δ {T}_{C} + Δ {T}_{R \times SRS} , P - {MPR}_{c} ) \}$$

$${P}_{CMAX \_ H} = MIN \{ 10 {log}_{10} \sum {p}_{EMAX , c} , {P}_{EMAX , CA} , {P}_{PowerClass , CA} - Δ {P}_{PowerClass , CA} \}$$

where
   p_{EMAX,c} is the linear value of p_{EMAX,c} which is given by IE P-Max for serving cell c in TS38.331 V17.3.0;
   P_{PowerClass,CA} is the maximum UE power specified in Table 6.2A.1.1-1 of 38.101-1, table 18, table 20, table 21, table 24 without taking into account the tolerance;
   MPR and A-MPR are specified in clause 6.2A.2 and 6.2A.3 38.101-1, respectively;
   ΔP_{PowerClass,CA}=3 dB for a power class 2 capable UE when 10 log₁₀ Σ_{PEMAX,c} of 23 dBm or lower is indicated; or when P_{EMAX,CA} of 23 dBm or lower is indicated; or when the field of UE capability maxUplinkDutyCycle-PC2-FR1 is absent and the percentage of total uplink symbols transmitted on all UL CCs in a certain evaluation period is larger than 50%; or when the field of UE capability maxUplinkDutyCycle-PC2-FR1 is not absent and the percentage of total uplink symbols transmitted in a certain evaluation period is larger than maxUplinkDutyCycle-PC2-FR1 as defined in TS 38.331 (The exact evaluation period is no less than one radio frame); otherwise Δ P_{PowerClass,CA}=0 dB;
   ΔT_{IB,c} is the additional tolerance for serving cell c as specified in clause 6.2A.4.2 of 38.101-1 for NR CA, clause 6.2C.2 of 38.101-1 for NR CA for SUL, or TS 38.101-3 clause 6.2B.4.2 of 38.101-1 for NR CA for EN-DC; In case the UE supports more than one of band combinations for CA, SUL or DC, and an operating band belongs to more than one band combinations then
a) When the operating band frequency range is ≤1 GHz, the applicable additional ΔT_{IB,c} shall be the average value for all band combinations defined in clause 6.2A.4.2 of 38.101-1 for NR CA, 6.2C.2 in of 38.101-1 for NR CA and 6.2B.4.2 in TS 38.101-3 V18.0.0, truncated to one decimal place that apply for that operating band among the supported band combinations. In case there is a harmonic relation between low band UL and high band DL, then the maximum ΔT_{IB,c} among the different supported band combinations involving such band shall be applied.
b) When the operating band frequency range is >1 GHz, the applicable additional ΔT_{IB,c} shall be the maximum value for all band combinations defined in clause 6.2A.4.2, 6.2C.2 i of 38.101-1 for NR CA and 6.2B.4.2 in TS 38.101-3 for the applicable operating bands.
   P-MPR is the power management term for the UE;
   ΔT_{C} is the highest value ΔT_{C,c} among all serving cells c;
   ΔT_{RxSRS} is the highest value among all serving cells c;
   P_{EMAX,CA} is the value indicated by p-NR-FR1 or by p-UE-FR1 whichever is the smallest if both are present.

For uplink intra-band contiguous carrier aggregation, when at least one different numerology/slot pattern is used in aggregated cells, the UE is allowed to set its configured maximum output power P_{CMAX,c(i),i} for serving cell c(i) of slot numerology type i, and its total configured maximum output power P_{CMAX}.

The configured maximum output power P_{CMAX,c(i),i}(p) in slot p of serving cell c(i) on slot numerology type i shall be set within the following bounds:

$${P}_{CMAX \_ L , f , c ( i ) , i} ( p ) \leq {P}_{CMAX , f , c ( i ) , i} ( p ) \leq {P}_{CMAX \_ H , f , c ( i ) , i} ( p )$$

where P_{CMAX_L,f,c(i),i}(p) and P_{CMAX_H,f,c(i),i}(p) are the limits for a serving cell c(i) of slot numerology type i as specified in clause 6.2.4 of 38.101-1 for NR CA.

The total UE configured maximum output power P_{CMAX}(p,q) in a slot p of slot numerology or symbol pattern i, and a slot q of slot numerology or symbol pattern j that overlap in time shall be set within the following bounds unless stated otherwise:

$${P}_{CMAX \_ L} ( p , q ) \leq {P}_{CMAX} ( p , q ) \leq {P}_{CMAX \_ H} ( p , q )$$

When slots p and q have different transmissions lengths and belong to different cells on different or same bands:

$${P}_{CMAX \_ L} ( p , q ) MIN \{ 10 {log}_{10} [ {p}_{CMAX \_ L , f , c ( i ) , i} ( p ) + {p}_{CMAX \_ L , f , c ( i ) , j} ( q ) ] , {P}_{PowerClass , CA} {P}_{EMAX \_ CA} \}$$

$${P}_{CMAX \_ H} ( p , q ) = MIN \{ 10 {log}_{10} [ {p}_{CMAX \_ H , f , c ( i ) , i} ( p ) + {p}_{CMAX \_ H , f , c ( i ) , j} ( q ) ] , {P}_{PowerClass , CA} , {P}_{EMAX \_ CA} \}$$

where p_{CMAX_Lf,c(i),i} and p_{CMAX_H,f,c(i),i} are the respective limits P_{CMAX_L,f,c (i),i} and P_{CMAX_H,f,c(i),i} expressed in linear scale.

T_{REF} and Tₑᵥₐₗ are specified in Table 6.2A.4.1.1-0 when same and different slot patterns are used in aggregated carriers. For each T_{REF}, the P_{CMAX_L} is evaluated per Tₑᵥₐₗ and given by the minimum value taken over the transmission(s) within the Tₑᵥₐₗ; the minimum P_{CMAX_L} over the one or more Tₑᵥₐₗ is then applied for the entire T_{REF}. The lesser of P_{PowerClass,CA} and P_{EMAX,CA} shall not be exceeded by the UE during any period of time.

TABLE 8

| | | Tₑᵥₐₗ with frequency |
|---|---|---|
| T_{REF} | Tₑᵥₐₗ | hopping |
| T_{REF} of largest slot duration | Physical | Min(Tₙₒ_hopping, Physical |
| over both UL CCs | channel length | Channel Length) |

Table 8 shows P_{CMAX} evaluation window for different slot and channel durations.

If the UE is configured with multiple TAGs and transmissions of the UE on slot i for any serving cell in one TAG overlap some portion of the first symbol of the transmission on slot i+1 for a different serving cell in another TAG, the UE minimum of P_{CMAX_L} for slots i and i+1 applies for any overlapping portion of slots i and i+1. The lesser of P_{PowerClass,CA} and P_{EMAX,CA} shall not be exceeded by the UE during any period of time.

The measured maximum output power P_{UMAX} over all serving cells with same slot pattern shall be within the following range:

$${P}_{CMAX \_ L} - MAX \{ {T}_{L} , {T}_{LOW} ( {P}_{CMAX \_ L} ) \} \leq {P}_{UMAX} \leq {P}_{CMAX \_ H} + {T}_{HIGH} ( {P}_{CMAX \_ H} ) {P}_{UMAX} 10 {log}_{10} \sum {p}_{UMAX , c}$$

where p_{UMAX,c} denotes the measured maximum output power for serving cell c expressed in linear scale. The tolerances T_{LOW}(P_{CMAX}) and T_{HIGH}(P_{CMAX}) for applicable values of P_{CMAX} are specified in Table 9. The tolerance T_{L} is the absolute value of the lower tolerance for applicable NR CA configuration as specified in Table 9 for intra-band carrier aggregation.

The measured maximum output power P_{UMAX} over all serving cells, when at least one slot has a different transmission numerology or slot pattern, shall be within the following range:

$${P}_{CMAX \_ L}^{′} - MAX \{ {T}_{L} , {T}_{LOW} ( {P}_{CMAX \_ L}^{′} ) \} \leq {P}_{UMAX}^{′} \leq {P}_{CMAX \_ H}^{′} + {T}_{HIGH} ( {P}_{CMAX \_ H}^{′} ) {P}_{UMAX}^{′} 10 {log}_{10} \sum {p}_{UMAX , c}^{′}$$

where p′_{UMAX,c} denotes the average measured maximum output power for serving cell c expressed in linear scale over T_{REF}. The tolerances T_{LOW}(P′_{CMAX}) and T_{HIGH}(P′_{CMAX}) for applicable values of P′_{CMAX} are specified in Table 9 for intra-band carrier aggregation. The tolerance T_{L} is the absolute value of the lower tolerance for applicable NR CA configuration as specified in Table 9 for inter-band carrier aggregation.
where:

$${P}_{CMAX \_ L}^{′} = MIN \{ MIN \{ 10 {log}_{10} \sum ( {p}_{CMAX \_ L , f , c ( i ) , i} ) , {P}_{PowerClass , CA} \} over all overlapping slots in {T}_{REF}$$

$${P}_{CMAX \_ H}^{′} = MAX \{ MIN \{ 10 {log}_{10} \sum {p}_{EMAX , c} , {P}_{PowerClass , CA} \} over all overlapping slots in {T}_{REF} \}$$

TABLE 9

| | Tolerance | Tolerance |
|---|---|---|
| P_{CMAX} | T_{LOW}(P_{CMAX}) | T_{HIGH}(P_{CMAX}) |
| (dBm) | (dB) | (dB) |
| 23 < P_{CMAX} ≤ 26 | 3 | 2 |

| | |
|---|---|
| 21 ≤ P_{CMAX} ≤ 23 | 2.0 |
| 20 ≤ P_{CMAX} < 21 | 2.5 |
| 19 b P_{CMAX} < 20 | 3.5 |
| 18 ≤ P_{CMAX} < 19 | 4.0 |
| 13 ≤ P_{CMAX} < 18 | 5.0 |
| 8 ≤ P_{CMAX} < 13 | 6.0 |
| −40 ≤ P_{CMAX} < 8 | 7.0 |

Table 9 shows examples of P_{CMAX} tolerance for uplink intra-band contiguous CA.

And, the rule of the applied requirement was defined in 6.2.1 of TS38.101-1 V18.0.0 as follows.

### 6.2A.1.1 UE Maximum Output Power for Intra-Band Contiguous CA

For uplink intra-band contiguous carrier aggregation, the maximum output power is specified in Table 6.2A.1.1-1. For downlink intra-band contiguous carrier aggregation with a single uplink component carrier configured in the NR band, the maximum output power is specified in Table 6.2.1-1 for power class 3 and other power classes if indicated in clause 5.5A.1.

TABLE 10

| NR CA | Class 1 | Tolerance | Class 2 | Tolerance | Class 3 | Tolerance | Class 4 | Tolerance |
|---|---|---|---|---|---|---|---|---|
| Configuration | (dBm) | (dB) | (dBm) | (dB) | (dBm) | (dB) | (dBm) | (dB) |
| CA_n7B | | | | | 23 | +2/−2 | | |
| CA_n40B | | | | | 23 | +2/−2 | | |
| CA_n41C | | | 26 | +2/−3 | 23 | +2/−2(NOTE | | |
| | | | | | | 1 applied) | | |
| CA_n48B | | | | | 23 | +2/−3 | | |
| CA_n77C | | | 26 | +2/−3 | 23 | +2/−3 | | |
| CA_n78C | | | 26 | +2/−3 | 23 | +2/−3 | | |
| CA_n79C | | | | | 23 | +2/−3 | | |

NOTE 1:
An uplink CA configuration in which the band has NOTE 3 in Table 6.2.1-1 of TS 38.101-1 is allowed to reduce the lower tolerance limit by 1.5 dB when the transmission bandwidths of the band are confined within F_{UL}_{_{—}}_{low} and F_{UL}_{_{—}}_{low} + 4 MHz or F_{UL}_{_{—}}_{high} − 4 MHz and F_{UL}_{_{—}}_{high}.
NOTE 2:
P_{PowerClass} is the maximum UE power specified without taking into account the tolerance.
NOTE 3:
For intra-band contiguous carrier aggregation the maximum power requirement shall apply to the total transmitted power over all component carriers (per UE).

Table 10 shows examples of UE Power Class for intra-band contiguous CA. Table 10 shows examples of NR CA configurations and corresponding power classes and tolerances.

6.2H.1.1 UE maximum output power for intra-band UL contiguous CA with UL MIMO.

For intra-band UL contiguous CA and UE with two transmit antenna connectors in closed-loop spatial multiplexing scheme, the maximum output power is defined as the sum of the maximum output power from both UE antenna connectors and all UL CCs. For example, if the UE supports UL MIMO and the UE is configured with intra-band UL contiguous CA, the UE needs to satisfy the following requirements. The period of measurement shall be at least one sub frame (1 ms), as specified in Table 11. The requirements shall be met with the UL MIMO configurations specified in Table 12 and Table 13 for 2 layer configuration and ULFPTx configuration respectively.

TABLE 11

| NR CA | Class 1 | Tolerance | Class 2 | Tolerance | Class 3 | Tolerance | Class 4 | Tolerance |
|---|---|---|---|---|---|---|---|---|
| Configuration | (dBm) | (dB) | (dBm) | (dB) | (dBm) | (dB) | (dBm) | (dB) |
| CA_n41C | | | 26 | +2/−3 | 23 | +2/−3 | | |
| | | | | (NOTE 1 | | (NOTE 1 | | |
| | | | | applied) | | applied) | | |
| CA_n78C | | | 26 | +2/−3 | 23 | +2/−3 | | |

NOTE 1:
If all transmitted resource blocks over all component carriers are confined within F_{UL}_{_{—}}_{low} and F_{UL}_{_{—}}_{low} + 4 MHz or/and F_{UL}_{_{—}}_{high} − 4 MHz and F_{UL}_{_{—}}_{high}, the maximum output power requirement is relaxed by reducing the lower tolerance limit by 1.5 dB
NOTE 2:
P_{PowerClass} is the maximum UE power specified without taking into account the tolerance

Table 11 shows examples of UE Power Class for intra-band UL contiguous CA with UL MIMO in closed loop spatial multiplexing scheme.

If UE is scheduled for single antenna-port PUSCH transmission by DCI format 0_0 or by DCI format 0_1 for single antenna port codebook based transmission, the requirements in clause 6.2A.1.1 apply for at least one antenna connector for the power class as indicated by the ue-PowerClass field in capability signalling.

### 6.2D.1 UE Maximum Output Power for UL MIMO

For UE with two transmit antenna connectors in closed-loop spatial multiplexing scheme, the maximum output power for any transmission bandwidth within the channel bandwidth is specified in Table 6.2D.1-1 of TS 38.101-1. The requirements shall be met with the UL MIMO configurations specified in Table 12. For UE supporting UL MIMO, the maximum output power is defined as the sum of the maximum output power from both UE antenna connectors. The period of measurement shall be at least one sub frame (1 ms).

The requirements shall be met with the UL MIMO configurations of using 2-layer UL MIMO transmission with codebook of

$$\frac{1}{\sqrt{2}} [ \begin{matrix}1 & 0 \\ 0 & 1\end{matrix} ] .$$

DCI Format for UE configured in PUSCH transmission mode for uplink single-user MIMO shall be used.

TABLE 12

| Transmission scheme | DCI format | Number of layers | TPMI index |
|---|---|---|---|
| Codebook based uplink | DCI format 0_1 | 2 | 0 |

NOTE 1:
The UE is configured with one SRS resource with the parameter nrofSRS-Ports set to 2.

Table 12 shows examples of UL MIMO configuration in closed-loop spatial multiplexing scheme.

For UE support uplink full power transmission (ULFPTx) for UL MIMO, the maximum output power requirements specified in Table 6.2D.1-1 of TS 38.101-1 shall be met with the PUSCH configurations specified in Table 13, based upon UE's support of uplink full power transmission mode.

TABLE 13

| | | | | Number | Number | |
|---|---|---|---|---|---|---|
| | Transmission | DCI | | of | of Tx | TPMI |
| ULFPTxMode | scheme | format | Modulation | layers | Port | index |
| Mode-1 | Codebook based | DCI format | DFT-s-OFDM, CP- | 1 | 2 | 2 |
| | uplink | 0_1 | OFDM (NOTE3 applied) | | | |
| Mode-2 | Codebook based | DCI format | DFT-s-OFDM, CP- | 1 | 2 | 0 or |
| | uplink | 0_1 | OFDM | | | 1(NOTE |
| | | | | | | 2 applied) |
| Mode-fullpower | Codebook based | DCI format | DFT-s-OFDM, CP- | 1 | 2 | 0, 1 |
| | uplink | 0_1 | OFDM | | | |

NOTE 1:
The UE is configured with one SRS resource with the parameter nrofSRS-Ports set to 2.
NOTE 2:
TPMI index selected shall be based upon the full power TPMI reported by the UE based on TS 38.213 V17.4.0.
NOTE 3:
For PUSCH configured with ULFPTxModes set to Mode-1, all the transmitter requirement for CP-OFDM based modulation is not needed to be verified if the requirement for UL MIMO has been validated.

Table 13 shows examples of PUSCH Configuration for uplink full power transmission (ULFPTx).

If the UE is scheduled for single antenna-port PUSCH transmission by DCI format 0_0 or by DCI format 0_1 for single antenna port codebook based transmission, the requirements in clause 6.2 apply for at least one antenna connector for the power class as indicated by the ue-PowerClass field in capability signalling with the following exception: for UEs indicating txDiversity-r16, the requirements in clause 6.2G for the power class indicated by the ue-PowerClass.

A UE indicating the feature ul-FullPwrMode-r16 or ul-FullPwrMode2-TPMIGroup-r16 for a band shall meet the requirement in the present disclosure for at least one antenna connector when scheduled for single antenna-port transmission by DCI format 0_0 or by DCI format 0_1 for codebook-based transmission on a single antenna port.

Examples of UE configured transmission power for single CC in un-licensed band are explained.

### 6.2F Transmitter Power for Shared Spectrum Channel Access

### 6.2F.4 Configured Transmitted Power

The requirements for configured maximum output power in clause 6.2.4 apply.

### 6.2F.4D Configured Transmitted Power UL MIMO

For UE supporting UL MIMO, the transmitted power is configured per each UE.

The definitions of configured maximum output power P_{CMAX,c}, the lower bound P_{CMAX_L,c}, and the higher bound P_{CMAX_H,c} specified in clause 6.2.4 shall apply to UE supporting UL MIMO, where
P_{PowerClass}, ΔP_{PowerClass} and ΔT_{C,c} are specified in clause 6.2.4 of 38.101-1 unless otherwise stated;
MPR_{c} is specified in clause 6.2F.2D of 38.101-1;
A-MPR_{c} is specified in clause 6.2F.3 of 38.101-1.

The measured configured maximum output power P_{UMAX,c} for serving cell c shall be within the following bounds:

$${P}_{CMAX \_ L , c} - MAX \{ {T}_{L} , {T}_{LOW} ( {P}_{CMAX \_ L , c} ) \} \leq {P}_{UMAX , c} \leq {P}_{CMAX \_ H , c} + {T}_{HIGH} ( {P}_{CMAX \_ H , c} )$$

where T_{LOW}(P_{CMAX_L,c}) and T_{HIGH}(P_{CMAX_H,c}) are defined as the tolerance and applies to P_{CMAX_L,c} and P_{CMAX_H,c} separately, while T_{L} is the absolute value of the lower tolerance in Table 14 for the applicable operating band.

For UE with two transmit antenna connectors in closed-loop spatial multiplexing scheme, the tolerance is specified in Table 14. The requirements shall be met with UL MIMO configurations specified in Table 12.

For UE supporting uplink full power transmission (ULFPTx) for UL MIMO, the tolerance is specified in Table 6.2F.4D-1. The requirements shall be met with the PUSCH configurations specified in Table 6.2D.1-3, based upon UE's support of uplink full power transmission mode.

TABLE 14

| | Tolerance | Tolerance |
|---|---|---|
| P_{CMAX,c} | T_{LOW}(P_{CMAX}_L,c) | T_{HIGH}(P_{CMAX}_H,c) |
| (dBm) | (dB) | (dB) |
| P_{CMAX,c} = 23 | 3.0 | 2.0 |
| 20 ≤ P_{CMAX,c} < 23 | 3.0 | 2.0 |
| 19 ≤ P_{CMAX,c} < 20 | 5.0 | 2.0 |
| 18 ≤ P_{CMAX,c} < 19 | 5.0 | 3.0 |
| 17 ≤ P_{CMAX,c} < 18 | 6.0 | 4.0 |

| | |
|---|---|
| 13 ≤ P_{CMAX,c} < 17 | 5.0 |
| 8 ≤ P_{CMAX,c} < 13 | 6.0 |
| −40 ≤ P_{CMAX,c} < 8 | 7.0 |

Table 14 shows examples of P_{CMAX,c} tolerance in closed-loop spatial multiplexing scheme.

### 6.2.4 Configured Transmitted Power

The UE is allowed to set its configured maximum output power P_{CMAX,f,c} for carrier f of serving cell c in each slot. The configured maximum output power P_{CMAX,f,c} is set within the following bounds:

$${P}_{CMAX \_ L , f , c} \leq {P}_{CMAX , f , c} \leq {P}_{CMAX \_ H , f , c} with {P}_{CMAX \_ L , f , c} = MIN \{ {P}_{EMAX , c} - Δ {T}_{C , c ,} ( {P}_{PowerClass} - Δ {P}_{PowerClass} ) - \\ MAX ( \text{} MAX ( {MPR}_{c} + Δ {MPR}_{c} , A - {MPR}_{c} ) + Δ {T}_{IB , c} + Δ {T}_{C , c} + Δ {T}_{RxSRS ,} P - {MPR}_{c} ) \}$$

$${P}_{CMAX \_ H , f , c} = MIN \{ {P}_{EMAX , c ,} {P}_{PowerClass} - Δ {P}_{PowerClass} \}$$

where
   P_{EMAX,c} is the value given by either the p-Max IE or the field additionalPmax of the NR-NS-PmaxList IE, whichever is applicable according to TS 38.331 V17.3.0. For example, a UE receives information related to P_{EMAX,c} such as p-Max IE or additionalPmax from a base station;
   P_{PowerClass} is the maximum UE power specified in Table 6.2.1-1 in 38.101-1 and in Table 6.2F.1-1 in 38.101-1 for shared spectrum access operation, without taking into account the tolerance specified in the Table 6.2.1-1 and in Table 6.2F.1-1 for shared spectrum access operation;
   When the IE powerBoostPi2BPSK is set to 1, P_{EMAX,c} is increased by +3 dB for a power class 3 capable UE operating in TDD bands n40, n41, n77, n78, and n79 with PI/2 BPSK modulation. The UE indicates support for UE capability powerBoosting-pi2BPSK and 40% or less symbols in certain evaluation period are used for UL transmission when P_{EMAX,c}≥20 dBm (The exact evaluation period is no less than one radio frame).
   When the IE powerBoostPi2BPSK is set to 1, ΔP_{PowerClass}−3 dB for a power class 3 capable UE operating in TDD bands n40, n41, n77, n78, and n79 with Pi/2 BPSK modulation and UE indicates support for UE capability powerBoosting-pi2BPSK and 40% or less slots in radio frame are used for UL transmission.

$$Δ {P}_{P owerClass} = \text{?}$$

$$\text{?} \text{indicates text missing or illegible when filed}$$

3 dB for a power class 2 capable UE or 6 dB for a power class 1.5 UE when P-max of 23 dBm or lower is indicated; or when the field of UE capability maxUplinkDutyCycle-PC2-FR1 is absent and the field of UE capability maxUplinkDutyCycle-PC1dot5-MPE-FR1 is absent and the percentage of uplink symbols transmitted in a certain evaluation period is larger than 50%; or when the field of UE capability maxUplinkDutyCycle-PC2-FR1 is not absent and the percentage of uplink symbols transmitted in a certain evaluation period is larger than maxUplinkDutyCycle-PC2-FR1 as defined in TS 38.306 (The exact evaluation period is no less than one radio frame); or when the field of UE capability maxUplinkDutyCycle-PC1dot5-MPE-FR1 is not absent and half the percentage of uplink symbols transmitted in a certain evaluation period is larger than maxUplinkDutyCycle-PC1dot5-MPE-FR1 as defined in TS 38.306 (The exact evaluation period is no less than one radio frame). For example, a condition based on any one among the mentioned when clauses is satisfied, 3 dB for a power class 2 capable UE or 6 dB for a power class 1.5 UE when P-max of 23 dBm or lower is indicated.
3 dB for a power class 1.5 capable UE when P-max of between 23 dBm and 26 dB is indicated; or when the field of UE capability maxUplinkDutyCycle-PC2-FR1 is absent and the field of UE capability maxUplinkDutyCycle-PC1dot5-MPE-FR1 is absent and the percentage of uplink symbols transmitted in a certain evaluation period is between 25% and 50%; or when the field of UE capability maxUplinkDutyCycle-PC2-FR1 is not absent and the percentage of uplink symbols transmitted in a certain evaluation period is between maxUplinkDutyCycle-PC2-FR1 and maxUplinkDutyCycle-PC2-FR1/2 as defined in TS 38.306 (The exact evaluation period is no less than one radio frame); or when the field of UE capability maxUplinkDutyCycle-PC1dot5-MPE-FR1 is not absent and the percentage of uplink symbols transmitted in a certain evaluation period is larger than maxUplinkDutyCycle-PC1dot5-MPE-FR1 as defined in TS 38.306 (The exact evaluation period is no less than one radio frame).
3 dB when the UE is configured with SUL configurations and the requirements of default power class are applied as specified in sub-clause 6.2C.1 on the band where UE indicates power class 2;
3 dB is applied during SRS transmission occasions with usage in SRS-ResourceSet set as ‘antennaSwitching’ with configured SRS resources in each SRS resource set(s) consisting of one SRS port when PC2 capable UE with txDiversity-r16 capability or PC1.5 capable UE further indicates SRS-TxSwitch capability ‘t1r2’ or ‘t1r4’ or ‘t1r1-t1r2’ or ‘t1r1-t1r2-t1r4’;
0 dB otherwise;
   ΔT_{IB,c} is the additional tolerance for serving cell c as specified in clause 6.2A.4.2 in TS38.101-1 for NR CA, clause 6.2C.2 for SUL, or TS 38.101-3 clause 6.2B.4.2 for EN-DC; ΔT_{IB,c}=0 dB otherwise; In case the UE supports more than one of band combinations for V2X operating bands for concurrent operation, CA, SUL or DC, and an operating band belongs to more than one band combinations then
a) When the operating band frequency range is ≤1 GHz, the applicable additional ΔT_{IB,c} shall be the average value for all band combinations defined in clause 6.2A.4.2, 6.2C.2 in TS38.101-1 and 6.2B.4.2 in TS 38.101-3 [3], truncated to one decimal place that apply for that operating band among the supported band combinations. In case there is a harmonic relation between low band UL and high band DL, then the maximum ΔT_{IB,c} among the different supported band combinations involving such band shall be applied
b) When the operating band frequency range is >1 GHz, the applicable additional ΔT_{IB,c} shall be the maximum value for all band combinations defined in clause 6.2A.4.2, 6.2C.2 in TS38.101-1 V18.0.0 and 6.2B.4.2 in TS 38.101-3 for the applicable operating bands.
ΔT_{C,c}=1.5 dB when NOTE 3 in Table 6.2.1-1 in 38.101-1 applies for a serving cell c, otherwise ΔT_{C,c}=0 dB;

MPR_{c} and A-MPR_{c} for serving cell c are specified in clause 6.2.2 and clause 6.2.3 in TS38.101-1, respectively and in clause 6.2F.2 and clause 6.2F.3 in TS38.101-1 respectively for shared spectrum access operation;

ΔMPR_{c} for serving cell c is specified in clause 6.2.2 in TS38.101-1 and in clause 6.2F.2 in TS38.101-1 for shared spectrum access operation.

ΔT_{RxSRS} is value related to SRS transmission

P-MPR_{c} is the power management maximum power reduction for
a) ensuring compliance with applicable electromagnetic energy absorption requirements and addressing unwanted emissions/self desense requirements in case of simultaneous transmissions on multiple RAT(s) for scenarios not in scope of 3GPP RAN specifications;
b) ensuring compliance with applicable electromagnetic energy absorption requirements in case of proximity detection is used to address such requirements that require a lower maximum output power.

The UE shall apply P-MPR_{c} for serving cell c only for the above cases. For UE conducted conformance testing P-MPR_{c} shall be 0 dB
NOTE 1: P-MPR_{c} was introduced in the P_{CMAX,f,c} equation such that the UE can report to the gNB the available maximum output transmit power. This information can be used by the gNB for scheduling decisions.
NOTE 2: P-MPR_{c} may impact the maximum uplink performance for the selected UL transmission path.

T_{REF} and Tₑᵥₐₗ are specified in Table 15. For each T_{REF}, the P_{CMAX,L,e} for serving cell c are evaluated per Tₑᵥₐₗ and given by the minimum value taken over the transmission(s) within the Tₑᵥₐₗ; the minimum P_{CMAX_L,f,c} over one or more Tₑᵥₐₗ is then applied for the entire T_{REF}.

TABLE 15

| T_{REF} | Tₑᵥₐₗ | Tₑᵥₐₗ with frequency hopping |
|---|---|---|
| Physical channel | Physical | Min(Tₙₒ_hopping, Physical |
| length | channel length | Channel Length) |

Table 15 shows examples of Evaluation and reference periods for Pcmax.

The measured configured maximum output power P_{UMAX,f,c} shall be within the following bounds:

$${P}_{CMAX \_ L , f , c} - MAX \{ {T}_{L , c ,} T ( {P}_{CMAX \_ L , f , c} ) \leq {P}_{UMAX , f , c} \leq {P}_{CMAX \_ H , f , c} + T ( {P}_{CMAX \_ H , f , c} ) .$$

where the tolerance T(P_{CMAX,f,c}) for applicable values of P_{CMAX,f,c} is specified in Table 15. The tolerance T_{L,c} is the absolute value of the lower tolerance for the applicable operating band as specified in Table 6.2.1-1 in TS 38.101-1 and in Table 6.2F.1-1 in TS 38.101-1 for shared spectrum access operation.

TABLE 16

| | Tolerance T(P_{CMAX,f,c}) |
|---|---|
| P_{CMAX,f,c} (dBm) | (dB) |
| 23 < P_{CMAX,c} ≤ 33 | 2.0 |
| 21 ≤ P_{CMAX,c} ≤ 23 | 2.0 |
| 20 ≤ P_{CMAX,c} < 21 | 2.5 |
| 19 ≤ P_{CMAX,c} < 20 | 3.5 |
| 18 ≤ P_{CMAX,c} < 19 | 4.0 |
| 13 ≤ P_{CMAX,c} < 18 | 5.0 |
| 8 ≤ P_{CMAX,c} < 13 | 6.0 |

Table 16 shows examples of P_{CMAX} tolerance. Table 16 shows tolerances T (P_{CMAX,f,c}) corresponding to the range for P_{CMAX,c}.

### 6.2F Transmitter Power for Shared Spectrum Channel Access

### 6.2F.1 UE Maximum Output Power

The following UE Power Classes define the maximum output power for any transmission bandwidth within the channel bandwidth of shared spectrum channel access carrier unless otherwise stated. The period of measurement shall be at least one sub frame (1 ms).

TABLE 17

| | | | | | | | | |
|---|---|---|---|---|---|---|---|---|
| NR | Class 1 | Tolerance | Class 2 | Tolerance | Class 3 | Tolerance | Class 5 | Tolerance |
| band | (dBm) | (dB) | (dBm) | (dB) | (dBm) | (dB) | (dBm) | (dB) |

| | | | | |
|---|---|---|---|---|
| n46 | 23 | +2/−3 | 20 | +2/−3 |
| n96 | 23 | +2/−3 | 20 | +2/−3 |
| n102 | 23 | +2/−3 | 20 | +2/−3 |

NOTE 1:
P_{PowerClass} is the maximum UE power specified without taking into account the tolerance
NOTE 2:
Power class 5 is default power class unless otherwise stated.

Table 17 shows examples of UE power class for shared spectrum channel access. Based on the examples of Table 17, power class 5 is default power class for the shared spectrum channel access.

### 6.2F.1A.2 UE Maximum Output Power for Intra-Band Contiguous CA

For uplink intra-band contiguous carrier aggregation, the maximum output power is specified in Table 18. For downlink intra-band contiguous carrier aggregation with a single uplink component carrier configured in the NR-U band, the maximum output power is specified in Table 17 for power class 5.

TABLE 18

| | | | | | | | | |
|---|---|---|---|---|---|---|---|---|
| NR CA | Class 1 | Tolerance | Class 2 | Tolerance | Class 3 | Tolerance | Class 5 | Tolerance |
| Configuration | (dBm) | (dB) | (dBm) | (dB) | (dBm) | (dB) | (dBm) | (dB) |

| | | |
|---|---|---|
| CA_n96B | 20 | +2/−3 |
| CA_n96C | 20 | +2/−3 |

NOTE 1:
P_{PowerClass} is the maximum UE power specified without taking into account the tolerance.
NOTE 2:
Power class 5 is default power class unless otherwise stated.

Table 18 shows examples of UE Power Class for intra-band contiguous CA.

### 5.5A.1 Configurations for Intra-Band Contiguous CA

Configurations for intra-band contiguous CA explains examples of Configurations for intra-band contiguous CA for unlicensed band.

Power class 3 is supported for all uplinks. Power classes other than power class 3 are supported as indicated in Table 19.

TABLE 19
NR CA configuration/Bandwidth combination set

| | Uplink CA | Channel | Channel | Channel | Channel | Channel | Maximum | |
|---|---|---|---|---|---|---|---|---|
| | configurations | bandwidths | bandwidths | bandwidths | bandwidths | bandwidths | aggregated | Bandwidth |
| NR CA | or single | for carrier | for carrier | for carrier | for carrier | for carrier | bandwidth | combination |
| configuration | uplink carrier | (MHz) | (MHz) | (MHz) | (MHz) | (MHz) | (MHz) | set |
| CA_n46B | — | 20, 40, 60 | 20, 40 | | | | 100 | 0 |
| CA_n46C | — | 60, 80 | 60, 80 | | | | 160 | 0 |
| CA_n46D | — | 60, 80 | 80 | 80 | | | 240 | 0 |
| CA_n46M | — | 20, 40, 60 | 20, 40 | 20, 40 | | | 140 | 0 |
| CA_n46N | — | 20, 40, 80 | 20, 40 | 20, 40 | 20, 40 | | 200 | 0 |
| CA_n46O | — | 20, 60 | 20, 40 | 20, 40 | 20, 40 | 20, 40 | 220 | 0 |
| CA_n96B | CA_n96B | 20, 40 | 20, 40, | | | | 100 | 0 |
| | | | 60, 80 | | | | | |
| CA_n96C | CA_n96C | 80 | 40, 60, 80 | | | | 160 | 0 |
| CA_n96D | | 80 | 80 | 60, 80 | | | 240 | 0 |
| CA_n96E | | 80 | 80 | 80 | 80 | | 320 | 0 |
| CA_n102B | — | 20, 40 | 20, 40, | | | | 100 | 0 |
| | | | 60, 80 | | | | | |
| CA_n102C | — | 80 | 40, 60, 80 | | | | 160 | 0 |
| CA_n102D | — | 80 | 80 | 60, 80 | | | 240 | 0 |
| CA_n102E | — | 80 | 80 | 80 | 80 | | 320 | 0 |

Hereinafter, examples of the present disclose explains requirements and operations for a UE supporting shared spectrum channel access and intra-band CA. The following Case 1, Case 2, and Case 3 are used as examples for specifying the requirements and the operations.

Case 1: NR-U UE configured transmission power for uplink intra band contiguous CA based on PC5 (20 dBm) and/or PC3 (23 dBm)

### UE Maximum Output Power for Intra-Band UL Contiguous CA

For NR-U uplink intra-band contiguous carrier aggregation, the maximum output power is specified in Table 20. For downlink intra-band contiguous carrier aggregation with a single uplink component carrier configured in the NR-U band, the maximum output power is specified in Table 20 (e.g., corresponds to Table 6.2F.1-1 of TS 38.101-1) for power class 5 and other power classes if indicated. (Here, default power class is power class 5).

TABLE 20

| | | | | | | | | |
|---|---|---|---|---|---|---|---|---|
| NR CA | Class 1 | Tolerance | Class 2 | Tolerance | Class 3 | Tolerance | Class 5 | Tolerance |
| Configuration | (dBm) | (dB) | (dBm) | (dB) | (dBm) | (dB) | (dBm) | (dB) |

| | | | | |
|---|---|---|---|---|
| CA_n96B | 23 | +2/−3 | 20 | +2/−3 |
| CA_n96C | 23 | +2/−3 | 20 | +2/−3 |

NOTE 1:
P_{PowerClass} is the maximum UE power specified without taking into account the tolerance.
NOTE 2:
Power class 5 is default power class unless otherwise stated.

Table 20 shows examples of NR-U UE Power Class for intra-band contiguous CA. Based on table 21, a UE supporting PC3 and/or PC5 may be configured with intra-band contiguous CA for shared spectrum channel access. Unless otherwise noted, the default power class for shared spectrum channel access is Power Class 5. For reference, “B” and “C” after band name n96 stands for CA bandwidth class explained in Table 7.

TABLE 21

| | | | | | | | | |
|---|---|---|---|---|---|---|---|---|
| NR | Class 1 | Tolerance | Class 2 | Tolerance | Class 3 | Tolerance | Class 5 | Tolerance |
| band | (dBm) | (dB) | (dBm) | (dB) | (dBm) | (dB) | (dBm) | (dB) |

| | | | | |
|---|---|---|---|---|
| n46 | 23 | +2/−3 | 20 | +2/−3 |
| n96 | 23 | +2/−3 | 20 | +2/−3 |
| n102 | 23 | +2/−3 | 20 | +2/−3 |

NOTE 1:
P_{PowerClass} is the maximum UE power specified without taking into account the tolerance
NOTE 2:
Power class 5 is default power class unless otherwise stated.

Table 21 shows examples of NR-U UE Power Class for single carrier.

Examples of UE configured transmission power for uplink intra band contiguous CA are explained.

For NR-U uplink carrier aggregation the UE is allowed to set its configured maximum output power P_{CMAX,c} for serving cell c and its total configured maximum output power P_{CMAX}. For example, an inter-band CA based on BandA and BandB may be configured for a UE. In this case, for each band-specific carrier, the configured transmitted power may be determined based on the formula for P_{CMAX,f,c}, as described in “6.2.4 Configured transmitted power” of this specification. When Pcmax,cc1 and Pcmax,cc2 are determined, the sum of Pcmax,cc1 and Pcmax,cc2 may not be equal to Pcmax, since different parameters are considered for each of Pcmax,cc1 and Pcmax,cc2. For example, Ppowerclass,cc1=23 dBm, Ppowerclass,cc2=26 dBm, and Ppowerclass,ca=26 dBm, or Pemax,cc1=23 dBm, Pemax,cc2=26 dBm, and Pemax,ca=26 dBm.

The configured maximum output power P_{CMAX,c} on serving cell c shall be set as specified in clause 6.2.4 in TS38.101-1, but with MPR_{c}=MPR and A-MPR_{c}=A-MPR with MPR as determined by subclause 6.2F.2 in TS38.101-1 for power class 5. The MPR for power class 3, and A-MPRs for power class 5 and power class 3 need to be defined. For PH (Power Headroom) reporting the following exception applies: if the UE is configured with multiple uplink serving cells, the power P_{CMAX,c} used for the purpose of PH reporting on first serving cell c=c₁ does not consider for computation of the PH report transmissions on a second serving cell c₂ as exempted in subclause 7.7.1 in TS38.213. There is one power management term for the UE, denoted P-MPR, and P-MPR_{c}=P-MPR.

The total configured maximum output power P_{CMAX} shall be set within the following bounds. For example, the UE may configure the total configured maximum output power to satisfy the following bounds:

$${P}_{CMAX \_ L} \leq {P}_{CMAX} \leq {P}_{CMAX \_ H}$$

For uplink intra-band contiguous carrier aggregation when same slot pattern is used in all aggregated serving cells,

$${P}_{CMAX \_ L} = MIN \{ 10 {log}_{10} Σ {p}_{EMAX , c} - Δ {T}_{c} , {P}_{EMAX , CA} , ( {P}_{PowerClass , CA} - Δ {P}_{PowerClass , CA} ) - Max ( Max ( MPR , A - MPR ) + Δ {T}_{IB , c} + Δ {T}_{C} + Δ {T}_{RxSRS ,} P - {MPR}_{c} ) \}$$

$${P}_{CMAX \_ H} = MIN \{ 10 {log}_{10} Σ {p}_{EMAX , c} {P}_{EMAX , CA} , {P}_{PowerClass , CA} - Δ {P}_{PowerClass , CA} \}$$

where
   p_{EMAX,c} is the linear value of P_{EMAX,c} which is given by IE P-Max for serving cell c in TS38.331;
      P_{PowerClass,CA} is the maximum UE power specified in Table 20 without taking into account the tolerance;
   MPR and A-MPR are for NR-U CA. Herein, NR-U CA may refer to CA for shared spectrum channel access.
   ΔP_{PowerClass,CA} is
   3 dB for a power class 3 capable UE when 10 log₁₀ ²p_{EMAX,c} of 20 dBm or lower is indicated; or when P_{EMAX,CA} of 20 dBm or lower is indicated;
   0 dB, otherwise;

Herein, p_{EMAX,c} is the linear value of P_{EMAX,c} which is given by IE P-Max for serving cell c. If the UE is configured with CA based on cc1 and cc2, NW may transmit P_{EMAX,cc1} for cc1, and P_{EMAX,cc2} for cc2 to the UE. The UE may convert P_{EMAX,cc1} and P_{EMAX,cc2}, which are both in dBm unit, to linear value and add them. The UE may convert the sum of linear values of P_{EMAX,cc1} and P_{EMAX,cc2} to dBm, the UE may compare the converted value with 20 dBm.

For another example, ΔP_{PowerClass,CA}, may be:
3 dB for a power class 3 capable UE when requirements of default power class are applied;
0 dB, otherwise.

For another example

ΔP_{PowerClass,CA} is:

0 dB and P_{PowerClass,CA} is replaced by 10 log₁₀ Σp_{PowerClass,c} if the UE indicates ‘higherPowerLimit-r17’

Herein, when the UE transmits higherPowerLimit-r17 to a NW, it means that the UE supports maximum output power being 24.7 dBm. For example, 24.7 dBm may be achieved by UE's transmitter combination with 1 PA of 23 dBm and 1 PA of 20 dBm.

That is, ‘higherPowerLimit-r17’ may be applied to intra-band CA.
ΔT_{IB,c}=0 for intra band contiguous CA
P-MPR is the power management term for the UE;
ΔT_{C} is the highest value ΔT_{C,c} among all serving cells c; (refer to 6.2.4 of TS 38.101-1)
ΔT_{RxSRS} is the highest value among all serving cells c;
Δp_{EMAX,CA} is the value indicated by p-NR-FR1 or by p-UE-FR1 whichever is the smallest if both are present.

For NR-U uplink intra-band contiguous carrier aggregation, at least one different numerology/slot pattern may be used in aggregated cells. In this case, the UE is allowed to set its configured maximum output power P_{CMAX,c(i),i} for serving cell c(i) of slot numerology type i, and its total configured maximum output power P_{CMAX}.

The configured maximum output power P_{CMAX,c(i),i}(p) in slot p of serving cell c(i) on slot numerology type i shall be set within the following bounds:

$${P}_{CMAX \_ L , f , c ( i ) , i} ( p ) \leq {P}_{CMAX , f , c ( i ) , i} ( p ) \leq {P}_{CMAX \_ H , f , c ( i ) , i} ( p )$$

where P_{CMAX_L,f,c(i),i}(p) and P_{CMAX_H,f,c(i),i}(p) are the limits for a serving cell c(i) of slot numerology type i as specified in clause 6.2.4 of TS 38.101-1.

The total UE configured maximum output power PCMAX(p,q) in a slot p of slot numerology or symbol pattern i, and a slot q of slot numerology or symbol pattern j that overlap in time shall be set within the following bounds unless stated otherwise:

$${P}_{CMAX \_ L} ( p , q ) \leq {P}_{CMAX} ( p , q ) \leq {P}_{CMAX \_ H} ( p , q )$$

When slots p and q have different transmissions lengths and belong to different cells on different or same bands:

$${P}_{CMAX \_ L} ( p , q ) = MIN \text{} \{ 10 {log}_{10} [ {p}_{CMAX \_ L , f , c ( i ) , i} ( p ) + {p}_{CMAX \_ L , f , c ( i ) , j} ( q ) ] , {P}_{PowerClass , CA} , {P}_{EMAX , CA} \}$$

$${P}_{CMAX\_H} ( p , q ) = MIN \text{} \{ 10 {log}_{10} [ {p}_{CMAX \_ H , f , c ( i ) , i} ( p ) + {p}_{CMAX \_ H , f , c ( i ) , j} ( q ) ] , {P}_{PowerClass , CA} , {P}_{EMAX , CA} \}$$

where p_{CMAX_L,f,c(i),i} and p_{CMAX_H,f,c(i),i} are the respective limits P_{CMAX_L,f,c(i),i} and P_{CMAX_H,f,c(i),i} expressed in linear scale.

T_{REF} and Tₑᵥₐₗ are specified in Table 6.2A.4.1.1-0 when same and different slot patterns are used in aggregated carriers. For each T_{REF}, the P_{CMAX_L} is evaluated per Tₑᵥₐₗ and given by the minimum value taken over the transmission(s) within the Tₑᵥₐₗ; the minimum P_{CMAX_L} over the one or more Tₑᵥₐₗ is then applied for the entire T_{REF}. The lesser of P_{PowerClass,CA} and P_{EMAX,CA} shall not be exceeded by the UE during any period of time.

TABLE 22

| | | Tₑᵥₐₗ with frequency |
|---|---|---|
| T_{REF} | Tₑᵥₐₗ | hopping |
| T_{REF} of largest slot duration | Physical | Min(Tₙₒ_hopping, Physical |
| over both UL CCs | channel length | Channel Length) |

Table 22 shows examples of P_{CMAX} evaluation window for different slot and channel durations.

The UE may be configured with multiple TAGs and transmissions of the UE on slot i for any serving cell in one TAG overlap some portion of the first symbol of the transmission on slot i+1 for a different serving cell in another TAG. In this case, the UE minimum of P_{CMAX_L} for slots i and i+1 applies for any overlapping portion of slots i and i+1. The lesser of P_{PowerClass,CA} and P_{EMAX,CA} shall not be exceeded by the UE during any period of time.

The measured maximum output power P_{UMAX} over all serving cells with same slot pattern shall be within the following range. For example, when the UE transmit signal based on the configured maximum output power, the signal from the UE may be measured. The UE may be tested to check whether the UE satisfies requirements related to measured maximum output power based on the following bounds:

$${P}_{CMAX \_ L} - MAX \{ {T}_{L} , {T}_{LOW} ( {P}_{CMAX \_ L} ) \} \leq {P}_{UMAX} \leq {P}_{CMAX \_ H} + {T}_{HIGH} ( {P}_{CMAX \_ H} )$$

$${P}_{UMAX} = 10 {log}_{10} Σ {p}_{UMAX , c}$$

where p_{UMAX,c} denotes the measured maximum output power for serving cell c expressed in linear scale. The tolerances T_{LOW}(P_{CMAX}) and T_{HIGH}(P_{CMAX}) for applicable values of P_{CMAX} are specified in Table 23. The tolerance T_{L} is the absolute value of the lower tolerance for applicable NR-U CA configuration as specified in Table 20 for NR-U intra-band carrier aggregation.

The measured maximum output power P_{UMAX} over all serving cells, when at least one slot has a different transmission numerology or slot pattern, shall be within the following range:

$${P}_{CMAX \_ L}^{′} - MAX \{ {T}_{L} , {T}_{LOW} ( {P}_{CMAX \_ L}^{′} ) \} \leq \text{} {P}_{UMAX}^{′} \leq {P}_{CMAX \_ H}^{′} + {T}_{HIGH} ( {P}_{CMAX \_ H}^{′} )$$

$${P}_{UMAX}^{′} = 10 {log}_{10} Σ {p}_{UMAX , c}^{′}$$

where p′_{UMAX,c} denotes the average measured maximum output power for serving cell c expressed in linear scale over T_{REF}. The tolerances T_{LOW}(P′_{CMAX}) and T_{HIGH}(P′_{CMAX}) for applicable values of P′_{CMAX} are specified in Table 6.2F.4.1.1-1 in TS 38.101-1 for NR-U intra-band carrier aggregation. The tolerance T_{L} is the absolute value of the lower tolerance for applicable NR-U CA configuration as specified in Table 20 for intra-band carrier aggregation,
where:

$${P}_{CMAX \_ L}^{′} = MIN \{ MIN \text{} \{ 10 {log}_{10} Σ ( {p}_{CMAX\_L , f , c ( i ) , i} ) , {P}_{PowerClass , CA} \} over all overlapping slots in {T}_{REF} \}$$

$${P}_{CMAX \_ H}^{′} = MAX \text{} \{ Min \text{} \{ 10 {log}_{10} Σ {p}_{EMAX , c} , {P}_{PowerClass , CA} \} over all overlapping slots in {T}_{REF} \}$$

TABLE 23

| | Tolerance | Tolerance |
|---|---|---|
| P_{CMAX,f,c} | T_{LOW}(P_{CMAX}) | T_{HIGH}(P_{CMAX}) |
| (dBm) | (dB) | (dB) |
| 21 ≤ P_{CMAX} ≤ 23 | 3.0 | 2.0 |

| | |
|---|---|
| 20 ≤ P_{CMAX} < 21 | 2.5 |
| 19 ≤ P_{CMAX} < 20 | 3.5 |
| 18 ≤ P_{CMAX} < 19 | 4.0 |
| 13 ≤ P_{CMAX} < 18 | 5.0 |
| 8 ≤ P_{CMAX} < 13 | 6.0 |
| −40 ≤ P_{CMAX} < 8 | 7.0 |

Table 23 shows examples of P_{CMAX} tolerance for NR-U uplink intra-band contiguous CA

According to examples of the present disclosure, Table 23 is proposed as Pcmax tolerance for NR-U uplink intra-band contiguous CA.

Case 2: NR-U UE configured transmission power for uplink intra band contiguous CA with UL-MIMO based on PC5 (20 dBm) and/or PC3 (23 dBm)

UE maximum output power for intra-band UL contiguous CA with UL MIMO

For NR-U uplink intra-band contiguous CA and UE with two transmit antenna connectors in closed-loop spatial multiplexing scheme, the maximum output power is defined as the sum of the maximum output power from both UE antenna connectors and all UL CCs. The period of measurement shall be at least one sub frame (1 ms), as specified in Table 24. The requirements shall be met with the UL MIMO configurations specified in Table 6.2D.1-2 and 6.2D.1-3 for 2 layer configuration and ULFPTx configuration respectively.

TABLE 24

| | | | | | | | | |
|---|---|---|---|---|---|---|---|---|
| NR CA | Class 1 | Tolerance | Class 2 | Tolerance | Class 3 | Tolerance | Class 5 | Tolerance |
| Configuration | (dBm) | (dB) | (dBm) | (dB) | (dBm) | (dB) | (dBm) | (dB) |

| | | | | |
|---|---|---|---|---|
| CA_n96B | 23 | +2/−3 | 20 | +2/−3 |
| CA_n96C | 23 | +2/−3 | 20 | +2/−3 |

NOTE 1:
P_{PowerClass} is the maximum UE power specified without taking into account the tolerance.
NOTE 2:
Power class 5 is default power class unless otherwise stated.

Table 24 shows examples of NR-U UE Power Class for uplink intra-band contiguous CA with UL MIMO in closed loop spatial multiplexing scheme.

The UE may be scheduled for single antenna-port PUSCH transmission by DCI format 0_0 or by DCI format 0_1 for single antenna port codebook based transmission. In this case the requirements based on Case 1 may apply for at least one antenna connector for the power class as indicated by the ue-PowerClass field in capability signalling.

Examples of UE configured transmission power for uplink intra band contiguous CA with UL-MIMO are explained.

For NR-U UE supporting intra-band UL contiguous CA with UL MIMO, the transmitted power is configured per each UE. Here, for UL-MIMO, it is assumed with two transmit antenna connectors in closed-loop spatial multiplexing scheme.

The definitions of configured maximum output power P_{CMAX,c}, the lower bound P_{CMAX_L,c}, and the higher bound P_{CMAX_H,c} specified in Case 1 shall apply to NR-U UE supporting intra-band UL contiguous CA with UL MIMO, where
ΔP_{PowerClass} and ΔT_{C,c} are specified as Case 1;
P_{PowerClass,CA} is the maximum UE power specified in Table 24 without taking into account the tolerance;
MPR, AMPR is specified as Case 1;
The measured configured maximum output power P_{UMAX} over all serving cells shall be within the following bounds:

$${P}_{CMAX \_ L} - MAX \{ {T}_{L} , {T}_{LOW} ( {P}_{CMAX \_ L} ) \} \leq {P}_{UMAX} \leq {P}_{CMAX \_ H} + {T}_{HIGH} ( {P}_{CMAX \_ H} )$$

where T_{LOW}(P_{CMAX_L}) and T_{HIGH}(P_{CMAX_H}) are defined as the tolerance and applies to P_{CMAX_L} and P_{CMAX_H} separately, while T_{L} is the absolute value of the lower tolerance in Table 24 for the applicable operating band.

For NR-U UE supporting intra-band UL contiguous CA with UL MIMO, the tolerance is specified as Table 23.

Case 3: NR-U UE configured transmission power for 2 Tx diversity based on PC3 (23 dBm)

Examples of UE maximum output power for 2 Tx diversity are explained.

For NR-U UE supporting Tx Diversity, the maximum output power as indicated by UE power class in Table 21 is defined as the sum of the maximum output power from both UE antenna connectors. The period of measurement shall be at least one sub frame (1 ms).

When a UE indicates PC3 for a given band it achieves maximum power by means of Tx Diversity in TS 38.101-1 V18.0.0.

If a UE supports a different power class than the default UE power class for the band and the supported power class enables the higher maximum output power than that of the default power class (=power class 5):
if the IE P-Max as defined in TS 38.331 is provided and set to the maximum output power of the default power class or lower;
   shall apply all requirements for the default power class to the supported power class and set the configured transmitted power as below.
else;
   shall apply all requirements for the supported power class and set the configured transmitted power as below.

Examples of UE configured transmission power for 2 Tx diversity are explained.

For NR-U UE supporting Tx diversity, the transmitted power is configured per each UE.

The definitions of configured maximum output power P_{CMAX,c}, the lower bound P_{CMAX_L,c}, and the higher bound P_{CMAX_H,c} specified in clause 6.2.4 in TS 38.101-1 shall apply to UE supporting Tx diversity, where

$${P}_{PowerClass ,} = UE power class for NR - U CA$$

Δ P_{PowerClass} is,
3 dB for a power class 3 capable UE when requirements of default power class are applied;
0 dB otherwise.
Δ T_{C,c} are specified as clause 6.2.4 in TS 38.101-1;
   MPR_{c} is specified as clause 6.2F.2 in TS 38.101-1;
   A-MPR_{c} is specified as clause 6.2F.3 in TS 38.101-1;

The measured configured maximum output power P_{UMAX,c} for serving cell c shall be within the following bounds:

$${P}_{CMAX \_ L , c} - MAX \{ {T}_{L} , {T}_{LOW} ( {P}_{CMAX \_ L , c} ) \} \leq {P}_{UMAX , c} \leq {P}_{CMAX \_ H , c} + {T}_{HIGH} ( {P}_{CMAX \_ H , c} )$$

where T_{LOW}(P_{CMAX_L,c}) and T_{HIGH}(P_{CMAX_H,c}) are defined as the tolerance and applies to P_{CMAX_L,c} and P_{CMAX_H,c} separately, while T_{L} is the absolute value of the lower tolerance in Table 21 for the applicable operating band.

For NR-U UE supporting Tx diversity, the tolerance is specified in Table 25.

TABLE 25

| | Tolerance | Tolerance |
|---|---|---|
| P_{CMAX,c} | T_{LOW}(P_{CMAX}_L,c) | T_{HIGH}(P_{CMAX}_H,c) |
| (dBm) | (dB) | (dB) |
| P_{CMAX,c} = 23 | 3.0 | 2.0 |
| 20 ≤ P_{CMAX,c} < 23 | 3.0 | 2.0 |
| 19 ≤ P_{CMAX,c} < 20 | 5.0 | 2.0 |
| 18 ≤ P_{CMAX,c} < 19 | 5.0 | 3.0 |
| 17 ≤ P_{CMAX,c} < 18 | 6.0 | 4.0 |

| | |
|---|---|
| 13 ≤ P_{CMAX,c} < 17 | 5.0 |
| 8 ≤ P_{CMAX,c} < 13 | 6.0 |
| −40 ≤ P_{CMAX,c} < 8 | 7.0 |

Table 25 shows examples of P_{CMAX,c} tolerance for Tx Diversity. Here, Table 25 is proposed as Pcmax tolerance for NR-U with Tx diversity.

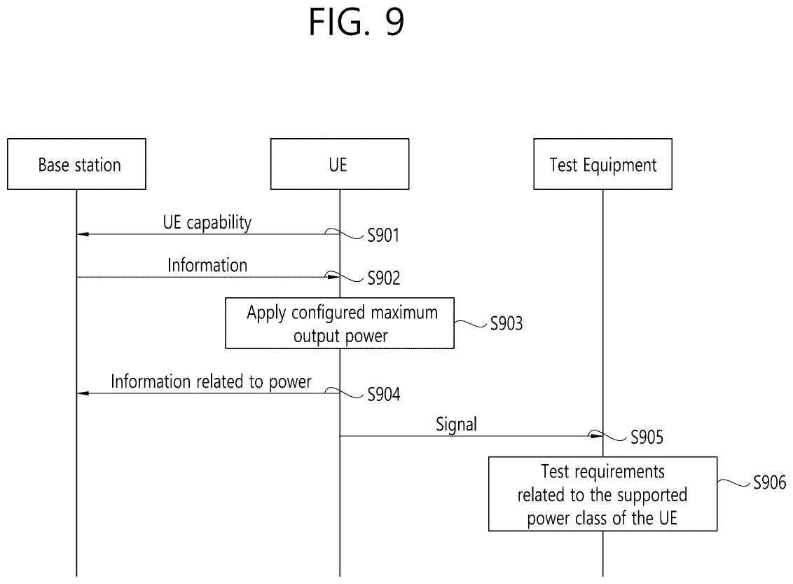

Based on examples explained in Case 1, 2, and 3, requirements related to transmitter power for shared spectrum channel access are explained. Operations of a UE, a gNB, and/or a test equipment based on the requirements related to transmitter power for shared spectrum channel access of the present disclosure are explained based on FIG. 9.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

FIG. 9 illustrates examples of operations according to an embodiment of the present disclosure.

FIG. 9 describes examples of operations of a UE, a base station (e.g., gNB), and a test equipment. Operations are related to UE configured transmission power.

In step S901, the UE may transmit UE capability information.

In step S902, the base station may transmit information to the UE. The information may include information related to power, operating band, and/or modulation.

In step S903, the UE may apply configured maximum output power. The UE may determine transmission power for transmission signal based on the configured maximum output power.

In step S904, the UE may transmit information related to power to the base station, the information related to the power may include P_{CMAX,c}, and/or PH_{c}. PH means Power headroom.

In step S905, the UE may transmit signal based on the configured maximum output power to the test equipment.

In step S906, the test equipment may test the requirements of the supported power class of the UE. The requirements are based on the examples of the present disclosure.

For reference, step S905 and S906 may be skipped. For another example, step S905 and S906 may be performed before the UE is sold to a user.
1) For a UE supporting NR-U and being configured with intra-band contiguous CA, the following descriptions are additionally applied to operations of FIG. 9.

FIG. 9 shows behaviors related to NR-U UE configured transmission power and the requirements to be tested for intra band contiguous CA. In the figure, UE may configure the transmission power based on at least one parameter among the supported power class, MPRc, A-MPRc, AMPRc, ΔTIB,c, ATC,c, ΔTRxSRS, P-MPRc, ΔP_{PowerClass,CA}.

In step S901, the UE transmits the UE capability information. The UE capability information may include one or more of ue-PowerClass, PowerClass, intraBandPowerClass, UE-PowerClassPerBandPerBC, TxDiversity, and ulFullPowerMode.

For example, if the UE communicates based on single carrier, the terminal may transmit its power class in the form of power class per Band. In this case, the device sends ‘ue-PowerClass’. If the UE communicates based on CA, the device may inform the network of its power class based on CA power (total sum power) and power per Band. For example, the UE may transmit ‘PowerClass’ and/or ‘intraBandPowerClass’ in the form of perBandCombination and ‘ue-PowerClass’ in the form of perBand to the network. For example, if a CA based on cc1 and cc2 is established, the UE may transmit the following information:—‘PowerClass’ per BandCombination (e.g., BandA, BandB combination)—‘intraBandPowerClass’ per BandCombination (e.g., BandA, Band A combination)—‘ue—PowerClass’ per Band A-‘ue-PowerClass’ per Band B. In addition, the UE may also transmit ue-PowerClassPerBandPerBC.
‘ue-PowerClassPerBandPerBC’ perBandperBC (power for Band A of {BandA, BandB}) If there are both ‘ue-PowerClass’ and ‘ue-PowerClassperBandperBC’ power classes for Band A, ‘ue-PowerClassperBandperBC’ shall take precedence.

TxDiversity is information related to whether the Tx antenna port including PA is 1 or 2 (diversity). ulFullPowerMode is information related to the type of Full Power mode (mode-full, mode-1, mode-2) if the UE supports UL MIMO.

The information of Step S902 may include one or more of p-Max information, Band information, UL modulation information. p-Max information may include P_{EMAX,c}, P_{EMAX,CA}. Band information may be the band information that has been implemented to enable the service.

For example the UE may determine (or define) supported power class, MPRc, A-MPRc, AMPRc, ΔTIB,c, ΔTC,c, ΔTRxSRS, P-MPR_{c}, ΔP_{PowerClass,CA}.

The apply configured maximum output power of Step S903 may be P_{CMAX}.
2) For a UE supporting NR-U and 2Tx diversity, the following descriptions are additionally applied to operations of FIG. 9.

FIG. 9 shows behavior of NR-U UE configured transmission power and measured configured transmission power for 2 Tx diversity. In the figure, UE may configure the transmission power based on at least one parameter among the supported power class, MPRc, A-MPRc, ΔMPRc, ΔTIB,c, ATC,c, ΔTRxSRS, P-MPR_{c}, ΔP_{PowerClass,CA}.

In step S901, the UE transmits the UE capability information. The UE capability information may include one or more of ue-PowerClass, TxDiversity, and ulFullPowerMode.Band information may be the band information that has been implemented to enable the service.

The information of Step S902 may include one or more of p-Max information, Band information, UL modulation information. p-Max information may include P_{EMAX,c}.

The UE may determine (or define) supported power class, MPRc, A-MPRc, ΔMPRc, ΔTIB,c, ATC,c, ΔTRxSRS, P-MPRc, ΔP_{PowerClass,CA}.

The apply configured maximum output power of Step S903 may be P_{CMAX,c}.

The following drawings are intended to illustrate specific embodiments of the present disclosure. The designations of specific devices or the designations of specific signals/messages/fields shown in the drawings are for illustrative purposes only, and the technical features of the present specification are not limited to the specific designations used in the drawings below.

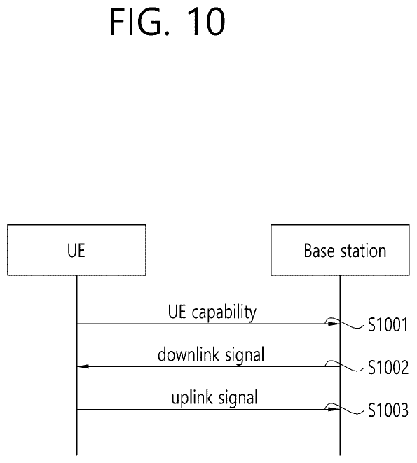

FIG. 10 illustrates an example of an operation according to an embodiment of the present disclosure.

In addition, the operations of the UE and the base station (e.g., gNB) shown in the example of FIG. 10 are only an example. The operation of the UE is not limited by the example of FIG. 10, and the UE and the base station may perform the operations described in various examples of the present specification.

In step S1001, the UE may transmit UE capability information to a base station. The UE supports shared spectrum channel access (e.g., NR-U). The capability information includes information that the UE supports power class 3 and information that the UE supports shared spectrum channel access.

The UE may transmit information that the UE supports higher power limit.

In step S1002, the base station may transmit downlink signal to the UE. For example, the base station may transmit downlink signal including one or more of p-Max information, Band information, UL modulation information. p-Max information may include P_{EMAX,c}, P_{EMAX,CA}. The base station may transmit information related to that the UE is configured with intra-band CA. The UE may be configured with intra-band CA.

In step S1003, the UE may transmit uplink signal. The UE may determine transmission power based on the configured maximum output power or the total configured maximum output power according to the present disclosure.

The UE is configured to satisfy requirements related to a configured transmitted power for the shared spectrum channel access. The requirements related to the configured transmitted power for the shared spectrum channel access includes requirements that a total configured maximum output power is to be set within bounds based on ΔP_{PowerClass,CA}.

For reference, according to the present disclosure, P_{PowerClass,CA} may refer to maximum power of the UE related to power class for CA. P_{PowerClass} may refer to maximum power of the UE related to power class. For example, P_{PowerClass,CA} or P_{PowerClass} is the maximum UE power specified in Table 6.2A.1.1-1 of 38.101-1, table 18, table 20, table 21, table 24 without taking into account the tolerance. For example, ΔP_{PowerClass,CA} may refer to difference value related to maximum power of the UE related to power class for CA. ΔP_{PowerClass} may refer to difference value related to may refer to difference value related to maximum power of the UE related to power class.

Herein the bounds may be: P_{CMAX_L}≤P_{CMAX}≤P_{CMAX_H}. herein both P_{CMAX_L} and P_{CMAX_H} are based on ΔP_{PowerClass,CA}.

For example, ΔP_{PowerClass,CA} may be equal to 3 dB, based on that the UE supports power class 3.

For example, ΔP_{PowerClass,CA} is equal to 3 dB, based on that the UE supports power class 3 when requirements of default power class for the shared spectrum channel access are applied. Based on that the UE does not support power class 3 or based on that the requirements of default power class for the shared spectrum channel access are not applied, ΔP_{PowerClass,CA} is equal to 0.

For example, ΔP_{PowerClass,CA} is equal to 0 and P_{PowerClass,CA} included in the bounds is replaced by 10 log₁₀Σp_{PowerClass,c}, based on that the UE supports the higher power limit.

According to an embodiments of the present disclosure, requirements related to NR-U UE configured transmission power for intra-band contiguous CA are explained. For example, the UE may set (or configure) its configured maximum output power P_{CMAX,c} for serving cell c and its total configured maximum output power P_{CMAX}. Applicable rules of MPRc, A-MPRc, ΔP_{PowerClass,CA} are defined. Measured P_{CMAX} tolerance is defined.

According to an embodiments of the present disclosure, requirements related to NR-U UE configured transmission power for intra-band contiguous CA with UL-MIMO are explained. The UE may set its configured maximum output power P_{CMAX,c} for serving cell c and its total configured maximum output power P_{CMAX}. Applicable rules of MPRc, A-MPRc, ΔP_{PowerClass,CA} are defined. Measured P_{CMAX} tolerance is defined.

According to an embodiments of the present disclosure, requirements related to NR-U UE configured transmission power for 2 Tx diversity are explained. For example, the UE may set (or configure) its configured maximum output power P_{CMAX,c} for serving cell c and its total configured maximum output power P_{CMAX}. Applicable rules of MPR_{c}, A-MPR_{c}, ΔP_{PowerClass,CA} are defined. Measured P_{CMAX} tolerance is defined.

According to an embodiments of the present disclosure, operations related to NR-U UE configured transmission power for intra band contiguous CA are explained.

According to an embodiments of the present disclosure, operations related to NR-U UE configured transmission power for 2Tx diversity are explained.

The present specification may have various effects.

For example, the UE may support intra-band contiguous CA for the shared spectrum channel access. That is, UE may support 23 dBm NR-U CA. By defining RF requirements for the UE, coverage can be extended. Also, the UE supporting intra-band contiguous CA for the shared spectrum channel access may perform communication efficiently and/or precisely.

The effects that may be obtained from the specific examples of this disclosure are not limited to those listed above. For example, there may be a variety of technical effects that a person having ordinary skill in the related art may understand or infer from this disclosure. Accordingly, the specific effects of the present disclosure are not limited to those expressly set forth herein, but may include a variety of effects that may be understood or inferred from the technical features of the present disclosure.

For reference, the operation of the terminal (e.g., UE) described in the present specification may be implemented by the apparatus of FIGS. 1 to 4 described above. For example, the terminal (e.g., UE) may be the first device 100 or the second device 200 of FIG. 2. For example, an operation of a terminal (e.g., UE) described herein may be processed by one or more processors 102 or 202. The operation of the terminal described herein may be stored in one or more memories 104 or 204 in the form of an instruction/program (e.g., instruction, executable code) executable by one or more processors 102 or 202. One or more processors 102 or 202 control one or more memories 104 or 204 and one or more transceivers 105 or 206, and may perform the operation of the terminal (e.g., UE) described herein by executing instructions/programs stored in one or more memories 104 or 204.

In addition, instructions for performing an operation of a terminal (e.g., UE) described in the present disclosure of the present specification may be stored in a non-volatile computer-readable storage medium in which it is recorded. The storage medium may be included in one or more memories 104 or 204. And, the instructions recorded in the storage medium may be executed by one or more processors 102 or 202 to perform the operation of the terminal (e.g., UE) described in the present disclosure of the present specification.

For reference, the operation of a network node (e.g., AMF, SMF, UPF, test equipment, etc.) or base station (e.g., NG-RAN, gNB, eNB, RAN, E-UTRAN etc.) described herein may be implemented by the apparatus of FIGS. 1 to 3 to be described below. For example, a network node or a base station may be the first device 100 of FIG. 2 or the second device 200 of FIG. 2. For example, the operation of a network node or base station described herein may be processed by one or more processors 102 or 202. The operation of the terminal described herein may be stored in one or more memories 104 or 204 in the form of an instruction/program (e.g., instruction, executable code) executable by one or more processors 102 or 202. One or more processors 102 or 202 may perform the operation of a network node or a base station described herein, by controlling one or more memories 104 or 204 and one or more transceivers 106 or 206 and executing instructions/programs stored in one or more memories 104 or 204.

In addition, instructions for performing the operation of the network node or base station described in the present disclosure of the present specification may be stored in a non-volatile (or non-transitory) computer-readable storage medium. The storage medium may be included in one or more memories 104 or 204. And, the instructions recorded in the storage medium are executed by one or more processors 102 or 202, so that the operations of a network node or base station are performed.

In the above, preferred embodiments have been exemplarily described, but the present disclosure of the present specification is not limited to such specific embodiments, and thus, modifications, changes, or may be improved.

In the exemplary system described above, the methods are described on the basis of a flowchart as a series of steps or blocks, but are not limited to the order of the steps described, some steps may occur in a different order or concurrent with other steps as described above. In addition, those skilled in the art will understand that the steps shown in the flowchart are not exclusive and that other steps may be included or that one or more steps of the flowchart may be deleted without affecting the scope of rights.

The claims described herein may be combined in various ways. For example, the technical features of the method claims of the present specification may be combined and implemented as an apparatus, and the technical features of the apparatus claims of the present specification may be combined and implemented as a method. In addition, the technical features of the method claim of the present specification and the technical features of the apparatus claim may be combined to be implemented as an apparatus, and the technical features of the method claim of the present specification and the technical features of the apparatus claim may be combined and implemented as a method.

1. A user equipment (UE) comprising:
at least one transceiver;
at least one processor; and
at least one memory that stores instructions and is operably electrically connectable with the at least one processor,
wherein the at least one processor is adapted to:
transmit capability information to a base station; and
transmit uplink signal based on a transmission power,
wherein the UE supports shared spectrum channel access,
wherein the UE is configured for intra-band contiguous Carrier Aggregation (CA),
wherein the at least one transceiver is configured to satisfy requirements related to a configured transmitted power for the shared spectrum channel access,
wherein the requirements related to the configured transmitted power for the shared spectrum channel access includes requirements that a total configured maximum output power is to be set within bounds based on difference value related to maximum power of the UE related to power class for CA,
wherein the difference value related to maximum power of the UE related to power class for CA is equal to 3 dB, based on that the UE supports power class 3.

2. The UE of claim 1,
wherein the difference value related to maximum power of the UE related to power class for CA is equal to 3 dB, based on that the UE supports power class 3 when requirements of default power class for the shared spectrum channel access are applied, and
wherein based on that the UE supports power class 3 when requirements of the supported power class for the shared spectrum channel access are applied, the difference value related to maximum power of the UE related to power class for CA is equal to 0.

3. The UE of claim 1, wherein the at least one processor is further adapted to:
determine the transmission power based on the configured transmitted power.

4. The UE of claim 1,
wherein the capability information includes information that the UE supports power class 3 or power class 5 and information that the UE supports shared spectrum channel access.

5. The UE of claim 1, wherein the at least one processor is further adapted to:
transmit information that the UE supports higher power limit,
wherein the difference value related to maximum power of the UE related to power class for CA is equal to 0 and P_{PowerClass,CA} included in the bounds is replaced by 10 log₁₀ Σp_{PowerClass,c}, based on that the UE supports the higher power limit.

6. The UE of claim 1,
wherein the bounds are:
P_{CMAX_L}≤P_{CMAX}≤P_{CMAX_H}, and
wherein both P_{CMAX_L} and P_{CMAX_H} are based on the difference value related to maximum power of the UE related to power class for CA.

7. A method performed by a User Equipment (UE) and comprising:
transmitting capability information to a base station; and
transmitting uplink signal based on a transmission power,
wherein the UE supports shared spectrum channel access,
wherein the UE is configured for intra-band contiguous Carrier Aggregation (CA),
wherein the at least one transceiver is configured to satisfy requirements related to a configured transmitted power for the shared spectrum channel access,
wherein the requirements related to the configured transmitted power for the shared spectrum channel access includes requirements that a total configured maximum output power is to be set within bounds based on difference value related to maximum power of the UE related to power class for CA-,
wherein the difference value related to maximum power of the UE related to power class for CA is equal to 3 dB, based on that the UE supports power class 3.

8. The method of claim 7,
wherein the difference value related to maximum power of the UE related to power class for CA is equal to 3 dB, based on that the UE supports power class 3 when requirements of default power class for the shared spectrum channel access are applied, and
wherein based on that the UE does not support power class 3 when requirements of default power class for the shared spectrum channel access are applied, the difference value related to maximum power of the UE related to power class for CA is equal to 0.

9. The method of claim 7, further comprising:
transmitting information that the UE supports higher power limit,
wherein the difference value related to maximum power of the UE related to power class for CA is equal to 0 and P_{PowerClass,CA} included in the bounds is replaced by 10 log₁₀ ΣP_{PowerClass,c}, based on that the UE supports the higher power limit.

10-11. (canceled)

12. A method performed by a base station and comprising:
receiving capability information to from a User Equipment (UE); and
receiving uplink signal transmitted based on a transmission power from the UE,
wherein the UE supports shared spectrum channel access,
wherein the UE is configured for intra-band contiguous Carrier Aggregation (CA),
wherein the at least one transceiver is configured to satisfy requirements related to a configured transmitted power for the shared spectrum channel access,
wherein the requirements related to the configured transmitted power for the shared spectrum channel access includes requirements that a total configured maximum output power is to be set within bounds based on difference value related to maximum power of the UE related to power class for CA,
wherein the difference value related to maximum power of the UE related to power class for CA is equal to 3 dB, based on that the UE supports power class 3.

13. The method of claim 12,
wherein the capability information includes information that the UE supports power class 3 and information that the UE supports shared spectrum channel access.

14. The method of claim 12, further comprising:
receiving information that the UE supports higher power limit,
wherein the difference value related to maximum power of the UE related to power class for CA is equal to 0 and P_{PowerClass,CA} included in the bounds is replaced by 10 log₁₀ Σp_{PowerClass,c}, based on that the UE supports the higher power limit.

15. (canceled)

16. The method of claim 7, further comprising:
determining the transmission power based on the configured transmitted power.

17. The method of claim 7,
wherein the capability information includes information that the UE supports power class 3 or power class 5 and information that the UE supports shared spectrum channel access.

18. The method of claim 7,
wherein the bounds are:
P_{CMAX_L}≤P_{CMAX}≤P_{CMAX_H}, and
wherein both P_{CMAX_L} and P_{CMAX_H} are based on the difference value related to maximum power of the UE related to power class for CA.
